(19) United States
(12) Patent Application Publication
(10) Pub. No.: US 2026/0331462 A1
(43) Pub. Date: Oct. 22, 2026

(54) 3D STRUCTURED ELECTRODES FOR ELECTROCHEMICAL CELLS

(71) Applicant: Conamix Inc., Ithaca, NY (US)

(72) Inventor: Stephen Burkhardt, Ithaca, NY (US)

(21) Appl. No.: 19/113,243

(22) PCT Filed: Sep. 21, 2023
(86) PCT No.: PCT/US2023/033359

§ 371 Date: Mar. 19, 2025

Related U.S. Application Data
(60) Provisional application No. 63/409,688, filed on Sep. 23, 2022.

(51) Int. Cl. H01M 4/136; H01M 4/02; H01M 4/04; H01M 4/134; H01M 4/1397; H01M 4/38; H01M 4/58; H01M 4/62; H01M 10/052; H01M 10/42

(52) U.S. Cl. CPC H01M 4/136; H01M 4/0404; H01M 4/0435; H01M 4/134; H01M 4/1397; H01M 4/382; H01M 4/5815; H01M 4/625; H01M 10/052; H01M 2004/021; H01M 2004/027; H01M 2004/028; H01M 2010/4292

(57) ABSTRACT

Described herein are, among other things, structured cathodes for use in electrochemical cells (e.g., batteries). In some embodiments, a structured cathode includes at least one electrochemically active material included in a patterned film. The film may be disposed on a substrate (e.g., current collector) or may be free standing. The film has at least one patterned surface, for example has recesses extending into the film. A patterned film may be porous. A patterned film may be made of an assembly of particles including an electrochemically active material. Recesses may include holes or trenches or a combination thereof. Recesses may be formed by removing material from an initial film, such as with laser ablation. Recesses may extend only partially into or entirely through a film. Recesses may be interconnected or separate. Recesses may be disposed regularly or irregularly across a patterned surface. Recesses may be at least partially filled with electrolyte.

### CROSS-REFERENCE TO RELATED APPLICATIONS

This application claims priority to U.S. Provisional Application No. 63/409,688, filed Sep. 23, 2022, which is incorporated herein by reference in its entirety.

### TECHNICAL FIELD

This disclosure relates generally to 3D structured cathodes for batteries.

### BACKGROUND

Certain batteries use cathodes that undergo large volume changes during electrochemical cycling. For example, batteries that use electrochemically active conversion materials in their cathodes will exhibit expansion and contraction in their cathodes due to conversion of the conversion materials from one form to another. One specific example of such a battery is a lithium-sulfur battery where conversion between sulfur and lithium sulfides causes large volume change in the cathode. Conversion towards Li₂S can impart significant volume expansion. Such expansion can have detrimental effects on the performance of the battery. For example, expansion can cause displacement of electrolyte out of the bulk of the cathode, which can then affect charging (and subsequent discharging) of the battery. Therefore, there is a need for cathode materials that mitigate the negative impacts of volume change during electrochemical cycling of batteries in which they are incorporated.

Another problem that may exist in certain battery chemistries using electrochemically active conversion materials in a cathode is formation of insoluble products during electrochemical cycling. Such products often deposit on surface(s) of the cathode, for example at a cathode-separator interface. The deposition of such product on such surface(s) reduces mass transport to the bulk of the cathode. Capacity can be thereby undesirably reduced during subsequent electrochemical cycles. Therefore, there is also a need for cathode materials that mitigate negative effects of uncontrolled deposition of insoluble products on future electrochemical cycling.

### SUMMARY

The present disclosure addresses problems caused by volume change during electrochemical cycling and/or insoluble product formation by using three-dimensionally structured cathodes (“structured cathodes” for short). Structured cathodes may include a cathode film that has a patterned surface with recesses extending into the film. In certain embodiments, a structured cathode includes an electrochemically active conversion materials (referred to as a “structured conversion cathode”). Different structured cathodes may be used in various electrochemical cells that have different chemistries. In some embodiments, a structured conversion cathode is used in a lithium-sulfur battery. Sulfur is a common electrochemically active conversion material but other materials, such as other chalcogenides (e.g., Se or Te), may be used.

Structured cathodes may be formed by providing (e.g., forming) a cathode film and then patterning a surface of the cathode film to have recesses, such as holes and/or trenches. For example, a cathode film may be deposited onto a substrate (e.g., current collector) and then patterned. Recesses may extend only partially into or entirely through a film. Recesses may be interconnected or separate. Recesses may be disposed regularly or irregularly across a patterned surface. Recesses may be at least partially filled with electrolyte in a battery. A cathode film may be calendered before patterning. Such ordering of steps may improve final cathode film structure as compared to a reverse order wherein calendering may undesirably alter or destroy intended recesses (e.g., morphology thereof). In certain embodiments, patterning is accomplished by removing material from a cathode film. Laser ablation is a particularly useful process for removing material as it is highly controllable, for example using precise laser placement, spot size, and exposure time. Moreover, laser ablation can be readily integrated into a cathode manufacturing process, such as a roll-to-roll process. Cost is a very important consideration for the competitiveness of certain battery technologies especially, such as lithium-sulfur batteries. The low cost of materials for lithium-sulfur batteries can justify added expense from laser ablation. In some embodiments, laser-ablation itself is low cost due to its ready integration into existing manufacturing processes. Therefore, cost-feasible structured conversion cathodes may be achieved for batteries. A pulsed laser may be used to perform laser ablation. In some embodiments, patterned compaction or other debossing process is performed to form recesses in a cathode film.

Unstructured conversion cathodes may undergo significant expansion during electrochemical cycling of a cell (e.g., conversion towards Li₂S in a lithium-sulfur battery). In particular expansion may cause a reduction in pore volume and a corresponding displacement of electrolyte out of the pore volume. In some cells, electrolyte may be displaced out of the cell stack and/or into void volumes that make it difficult for electrolyte to be transported back into the porosity upon charging of the cell even when reduction in cathode volume occurs (e.g., when one or more lithium sulfides, like Li₂S, convert back to S). Recesses in a patterned cathode surface can provide locations for local reservoirs for electrolyte. Electrolyte can move into such reservoir locations readily during cathode expansion and more easily transport back into bulk of a cathode as cathode volume reduces.

Additionally or alternatively, recesses in a patterned cathode surface can provide shorter mass transport distance for electroactive species (e.g., Li⁺) into and out of bulk of a cathode. Without wishing to be bound by any particular theory, by reducing mass transport distance, greater utilization of available ion storage capacity in the cathode can be realized. In a non-structured cathode, mass transport is determined primarily by the thickness of the film. In a structured cathode, recesses provide shorter transport distances into bulk of a film because the recesses extend into the cathode film. Recesses in a patterned surface of a cathode film may lead to a higher rate and/or greater extent of ion transport (e.g., lithium ion transport) into and/or out of the cathode film during electrochemical cycling.

Additionally or alternatively, an electrochemical cell may be structured such that insoluble products (e.g., non-equilibrium products) form during electrochemical cycling of the cell. Such products may be formed at and/or transported to a cathode-separator interface in an electrochemical cell. In an unstructured cathode, a layer may form that inhibits transport to and from bulk of the cathode across the entire interior cathode surface (e.g., the surface that is not in contact with a current collector). Recesses in a structured cathode may provide areas without insoluble products or with a reduced concentration of insoluble products. Thus, while transport through uppermost portions of the patterned surface that are not recessed may be impeded by formation of an insoluble product layer, transport through recesses may occur at a greater rate or even unabated.

Additionally or alternatively, using a patterned cathode film enables improved mixed electrolyte systems that can utilize advantages of both solid and polymer, gel, or liquid electrolytes. For example, a solid electrolyte may be disposed directly on a structured cathode. Due to recesses in the structured cathode, volume still exists for polymer, gel, or liquid electrolyte even though uppermost portions of a surface of the structure cathode are in contact with the solid electrolyte. In such a way, an electrochemical cell can achieve both benefits of a solid electrolyte (e.g., reducing polysulfide shuttling in a lithium-sulfur battery) and a polymer, gel, or liquid electrolyte (e.g., faster kinetics).

Benefits of structured cathodes disclosed herein for lithium-sulfur batteries may alternatively or additionally include: (i) improved reversible transport of polysulfides during cycling through reduced tortuosity of the cathode, mitigating deleterious power fade from nonequilibrium redox reactions; (ii) improved electrolyte management as electrolyte is extruded from the cathode porosity as sulfur is converted to lithium sulfide, expanding into the porosity in the process; (iii) high volumetric capacity achieved through the use of low E/S ratios enabled by a heavily calendered cathode with improved electrolyte transport from strategically shaped and placed patterned structures (e.g., laser-ablated structures) (e.g., microstructures). The present disclosure enables tuned cathodes for lithium-sulfur batteries that balance design requirements for both high sulfur utilization and high energy: high internal surface area, low tortuosity, porosity to match ultra-low E/S ratios and displacement of electrolyte due to sulfur expansion upon conversion. Those of ordinary skill will appreciate that similar or identical benefits may also be achieved in other battery chemistries, such as, but not limited to, sodium-sulfur batteries.

In some embodiments, a battery may be constructed using a structured cathode disclosed herein that achieves one or more of the following performance metrics: (i) a gravimetric energy density (Wh/kg) of at least 550; (ii) a volumetric energy density (Wh/L) of at least 900; (iii) a charge power/acceptance (kW/kg) of at least 1.3; (iv) a performance loss per °C (%, ≤30 °C to −20 °C) of no more than 0.4; (v) cycle life at at least 90% of initial capacity (80% state of charge (SOC) swing) of at least 750; and (vi) a cell cost target ($/kWh) of no more than 60. In some embodiments, additional technology beyond simply using a structured cathode is utilized in order to achieve one or more of these performance metrics. For example, thin film solid-state separator technologies (SwRI) like sputtered/evaporated LLZO2; atomic layer deposition (ALD) coatings that enhance Li-plating rate, prevent dendrites, and ensure chemical stability; and/or integration of structured cathodes with solid-state protection of a Li anode may be used.

In some aspects, the present disclosure provides for electrodes for a secondary lithium battery (e.g., a lithium-sulfur battery), the electrode comprising a film comprising an electrochemically active material. The film may have a first surface in contact with a substrate (e.g., a current collector) and a patterned second surface on a side of the film opposite the first surface (e.g., not in contact with the substrate). The patterned second surface comprises recesses that extend into the film toward the substrate (e.g., in a direction substantially perpendicular to the first surface.) In some embodiments, the electrode is a cathode. In some embodiments, the electrochemically active material is an electrochemically active conversion material.

In some embodiments, the patterned second surface of the film has a repeated geometric pattern of the recesses. For example, the repeating geometric pattern may conform to a hexagonal grid. As another example, the repeating geometric pattern may conform to an isometric grid or to a square grid.

In some embodiments, at least a portion of the recesses may be interconnected across the second surface (e.g., form a network of the recesses across an extent of the second surface). The recesses in the second surface of the film may comprise holes. In some embodiments, the holes may be substantially circular in cross section.

In some embodiments, a diameter of the holes may be at least 20 nm and no more than 500 μm (e.g., 20 nm to 50 μm, 20 nm to 100 μm, 20 nm to 200 μm, 20 nm to 300 μm, 100 nm to 100 μm, 100 nm to 200 μm, 1 μm to 100 μm, 1 μm to 200 μm, 10 μm to 100 μm, 10 μm to 200 μm, 50 μm to 100 μm, 50 μm to 200 μm, or 100 μm to 200 μm). A diameter of the holes may correspond to a resolution limit of a laser used to form the holes.

In some embodiments, the holes each may have a depth that is at least 25% of a thickness of the electrode film (e.g., a depth that is at least 50%, at least 75%, at least 80% or at least 90% of the thickness of the electrode film) or wherein the holes extend entirely through the film from the second surface to the first surface.

Additionally or alternatively, in some embodiments, the recesses of a presently disclosed electrode may comprise trenches, wherein the trenches may have a width and a length across the second surface. For example, the width may be less than the length. In some embodiments, the width the width is at least 20 nm and no more than 500 μm (e.g., 20 nm to 50 μm, 20 nm to 100 μm, 20 nm to 200 μm, 20 nm to 300 μm, 100 nm to 100 μm, 100 nm to 200 μm, 1 μm to 100 μm, 1 μm to 200 μm, 10 μm to 100 μm, 10 μm to 200 μm, 50 μm to 100 μm, 50 μm to 200 μm, or 100 μm to 200 μm). A width of a trench may correspond to a resolution limit of a laser used to form the trench.

The trenches may each have a depth that is at least 25% of a thickness of the cathode film (e.g., a depth that is at least 50%, at least 75%, at least 80% or at least 90% of the thickness of the cathode film) or wherein the trenches extend entirely through the film from the second surface to the first surface.

In some embodiments, the recesses may be at least partially filled with electrolyte. For example, an electrolyte may comprise a polymer. In some cases, the electrolyte may be a liquid or may be a solid.

In some embodiments, the recesses of presently disclosed electrodes may be distributed in a regular pattern across the second surface of the film. For example, the recesses may be distributed across the second surface that no point within the film is more than 500 μm (e.g., no more than 200 μm, no more than 100 μm, no more than 50 μm, no more than 25 μm, or no more than 20 μm) from at least one edge of at least one of the recesses.

Additionally or alternatively, the recesses may be distributed across the second surface such that any point within the film is within a distance of a closest one of the recesses that is no more than three times (e.g., no more than twice or no more than 1.5×) a maximum thickness of the film. In some embodiments, the distance is no more than the maximum thickness of the film.

In some embodiments, the recesses of disclosed electrodes disclosed may represent at least 5% (e.g., at least 10%, at least 15%, at least 20%, at least 25%, at least 33% or at least 50%) of total volume contained between a plane coincident with an uppermost portion of the second surface and the first surface.

In some cases, surfaces of the recesses (e.g., portions of the second surface defined by the recesses) can be coated with a solid material having a composition different from composition of bulk electrode in the film. For example, the surfaces of the recesses may be coated with a solid epitaxial material (e.g., formed by atomic layer deposition after formation of the recesses).

In some embodiments, at least some (e.g., all) of the recesses extend entirely through the film. In some embodiments, at least some (e.g., all) of the recesses do not extend entirely through the film.

In some embodiments, the film of a disclosed electrode is a first film and the electrode further comprises a second film disposed on a side of the substrate opposite the first film.

In some embodiments, the second film has a patterned second surface comprising recesses that extend into the second film and a first surface opposing the second surface, wherein the first surface of the second film is in contact with the substrate. In some embodiments, the substrate may be porous. The recesses in the first film may extend entirely through the first film and intersect with pores in the substrate. Alternatively or additionally, the pores in the substrate extend entirely through the substrate (e.g., thereby defining pores entirely through the electrode).

In some embodiments of presently disclosed electrodes, the second surface of the film may be patterned after the film has been applied to the substrate. For example, the film may be produced by applying a wet slurry to the substrate and subsequently drying the slurry prior to patterning.

In some embodiments, the film may be calendered prior to patterning the second surface.

In some embodiments, the second surface of presently disclosed electrodes may be patterned by laser ablation.

For example, the laser ablation may pattern the second surface using a pulsed laser. In some embodiments, the pulsed laser may apply pulses of a duration of less than 1000 femtoseconds (e.g., less than 500, 400, 300, 200, 150, 100, 50, 25, 15, 10, 5, 4, 3, 2, or 1 fs).

In some embodiments, the film of disclosed electrodes may be porous [e.g., is a porous assembly of individual structures (e.g., particles) (e.g., nanoparticles) (e.g., core-shell or yolk-shell particles)].

In some presently disclosed electrodes, the electrochemically active material (e.g., the electrochemically active conversion material) comprises (i) elemental sulfur (e.g., in its S₈ cyclic octatomic molecular form), (ii) sulfur in the form of a lithium sulfide (e.g., Li₂S₂ and/or Li₂S), (iii) sulfur in the form of an electrochemically active organosulfur compound, (iv) sulfur in the form of an electrochemically active sulfur-containing polymer, or (v) a combination of any two or more of (i)-(iv).

Additionally or alternatively, disclosed electrode films may further comprise one or more metal sulfides. For example, at least one of the one or more metal sulfides may be an intercalation electrochemically active material.

Alternatively or additionally, in some embodiments, disclosed electrodes may further comprise a conductive additive (e.g., conductive carbon).

Alternatively or additionally, disclosed electrodes may further comprise a polymer binder.

In some embodiments, disclosed electrodes may be substantially devoid of carbon, (e.g., no more than 10 wt % carbon, no more than 5 wt % carbon, no more than 2 wt % carbon, or no more than 1 wt % carbon).

In some embodiments, presently disclosed electrodes may provide for (i) an average mass transport path to the electrochemically active material (e.g., electrochemically active conversion material) shorter than an average mass transport path to the electrochemically active material in an otherwise equivalent cathode without the recesses; (ii) a tortuosity of the electrode is reduced compared to a tortuosity of an otherwise equivalent electrode without the recesses; or (iii) both (i) and (ii).

Additionally or alternatively, presently disclosed electrodes may provide for (i) a capacity of the electrode greater than a capacity of an otherwise equivalent cathode without the recesses at a same current density; (ii) the electrode having a high volumetric capacity; or (iii) both (i) and (ii).

In some embodiments, the present disclosure provides for secondary batteries (e.g., lithium-sulfur) comprising exemplary electrodes disclosed herein.

In some embodiments, presently disclosed batteries may further comprise an electrolyte disposed in the film of disclosed electrodes, wherein the recesses are local reservoirs for portions of the electrolyte displaced from bulk of the film during electrochemical cycling of the battery.

Additionally or alternatively, disclosed batteries may further comprise a liquid electrolyte that at least partially fills the recesses of disclosed electrodes (e.g., wherein the liquid electrolyte also directly contacts the second surface where not recessed). For example, in some embodiments, the secondary battery may further comprise a solid, polymer, or gel electrolyte (e.g., polymer gel electrolyte) that at least partially fills the recesses.

In some embodiments, secondary batteries may further comprise a liquid electrolyte that is in contact with the solid, polymer, or gel electrolyte (e.g., wherein the liquid electrolyte is disposed in the recesses of disclosed electrodes and the solid, polymer, or gel electrolyte directly contacts the second surface).

Additionally or alternatively, secondary batteries may further comprise a non-conductive separator, wherein the second surface of the film of disclosed electrodes is in contact with the non-conductive separator (e.g., at non-recessed portions of the second surface) [e.g., thereby defining a separator-electrode interface and wherein non-equilibrium insoluble product is disposed (e.g., precipitated) at a higher concentration on the surface of the film at the separator-electrode interface than in the recesses].

Presently disclosed secondary batteries may further comprise a solid electrolyte, wherein the second surface of the film of disclosed electrodes is in contact with the solid electrolyte (e.g., at non-recessed portions of the second surface).

Additionally or alternatively, disclosed secondary batteries may further comprise a protected lithium anode wherein the second surface of the film of disclosed electrodes (e.g., a conversion cathode) is in contact with the protected lithium anode.

In some embodiments, presently disclosed secondary batteries may have an anode-free configuration (e.g., wherein the battery comprises a current collector and lithium deposits on the current collector during a first electrochemical cycle).

In some embodiments, electrolytes of presently disclosed secondary batteries may not include a sulfonamide salt (e.g., lithium bis(trifluoromethanesulfonyl)imide (LiTFSI)).

In some embodiments, disclosed secondary batteries may have a low electrolyte to sulfur (E/S) ratio.

In some embodiments, the present disclosure provides methods of operating presently disclosed secondary batteries (e.g., lithium-sulfur battery) comprising electrodes disclosed herein (e.g., a conversion cathode) and an electrolyte, the method comprising expanding the film of disclosed electrodes during electrochemical cycling of the battery (e.g., while discharging the battery) [e.g., due to expanding of individual structures (e.g., particles) assembled in the film] (e.g., due to reduced porosity in the film) such that a portion of the electrolyte is displaced from bulk of the film into the recesses.

In some embodiments, disclosed methods of operating may further comprise displacing the portion of the electrolyte back into the bulk of the film during further electrochemical cycling of the battery (e.g., while charging the battery) (e.g., due to shrinkage of the film).

In some embodiments, the battery of the method of operating may further comprise a separator in contact with the second surface of the film of disclosed electrodes (e.g., a cathode) thereby defining a separator-electrode interface and the method comprises forming non-equilibrium insoluble product during electrochemical cycling and disposing (e.g., precipitating) the non-equilibrium insoluble product on the surface of the film at the separator-electrode interface.

In some embodiments, disclosed methods of operating may comprise the non-equilibrium insoluble product disposing on the surface of the film of disclosed electrodes at the separator-electrode interface at a higher concentration than the non-equilibrium insoluble product disposes in the recesses.

In some embodiments, disclosed methods of operating may comprise the non-equilibrium insoluble product not being disposed in the recesses.

In some embodiments, disclosed methods of operating may comprise reversibly transporting lithium (e.g., in the form of a polysulfide) into the electrode (e.g., conversion cathode) via the recesses during electrochemical cycling.

Additionally or alternatively, methods of operating disclosed herein may comprise transporting of lithium into the electrode (e.g., conversion cathode) via the recesses occurs at a higher rate and/or to a greater extent (e.g., based on an amount of lithium transported) than a rate and/or extent that transporting lithium through surface having the non-equilibrium insoluble product disposed thereon simultaneously occurs.

Further, methods of operating may comprise wherein electrolyte displacement into a cell stack and/or one or more voids of the battery during electrochemical cycling is reduced due to the displacement into the recesses.

In some aspects, the present disclosure provides methods of making an electrode (e.g., a cathode) for a battery (e.g., a lithium-sulfur battery), the method of making comprising providing (e.g., forming) a film comprising electrochemically active material (e.g., electrochemically active conversion material). In some embodiments, the method further comprises forming recesses in a surface of the film that extend into the film. In some embodiments, forming recesses may comprise removing a portion of the film.

In some embodiments, removing may comprise laser ablating the film. In some embodiments, laser ablating comprises applying a pulsed laser to the film. For example, the pulsed laser may apply pulses of a duration of less than 1000 femtoseconds (e.g., less than 500, 400, 300, 200, 150, 100, 50, 25, 15, 10, 5, 4, 3, 2, or 1 fs).

In some embodiments, the laser ablating may be performed in-line (e.g., during fabrication of a battery).

In some embodiments, methods of making may comprise calendering the film [e.g., on a substrate (e.g., current collector)]. In some embodiments, forming may occur after calendering. In some embodiments, (i) the calendering has left no more than 40% (e.g., no more than 30%, no more than 20%, or no more than 10%) of an initial porosity of the film before calendering, (ii) a maximum thickness of the film is no more than 40% (e.g., no more than 30%, no more than 20%, or no more than 10%) of an initial thickness before calendering, or (iii) both (i) and (ii).

In some embodiments, forming may comprise scraping, cutting, and/or scratching (e.g., with one or more blades). In some embodiments, forming may comprise debossing (e.g., compacting, imprinting, and/or stamping) the film.

In some embodiments wherein the providing comprises forming the film, the forming the film may comprise assembling individual structures (e.g., particles) comprising the electrochemically active material (e.g., electrochemically active conversion material).

In some embodiments, assembling may comprise one or more members selected from the group consisting of slurry coating, slot-die coating, spin coating, spray drying, draw-down coating, doctor-blade coating, inkjet printing, comma-coating, and reverse comma-coating.

In some embodiments, the method may be performed as part of a roll-to-roll manufacturing process (e.g., a roll-to-roll cathode manufacturing process or roll-to-roll battery manufacturing process).

Any two or more of the features described in this specification, including in this summary section, may be combined to form implementations not specifically explicitly described in this specification.

### DEFINITIONS

In order for the present disclosure to be more readily understood, certain terms used herein are defined below. Additional definitions for the following terms and other terms may be set forth throughout the specification.

In this application, unless otherwise clear from context or otherwise explicitly stated, (i) the term “a” may be understood to mean “at least one”; (ii) the term “or” may be understood to mean “and/or”; (iii) the terms “comprising” and “including” may be understood to encompass itemized components or steps whether presented by themselves or together with one or more additional components or steps; (iv) the terms “about” and “approximately” may be understood to permit standard variation as would be understood by those of ordinary skill in the relevant art; and (v) where ranges are provided, endpoints are included.

About, Approximately: As used herein, the terms “about” and “approximately” are used as equivalents. Unless otherwise stated, the terms “about” and “approximately” may be understood to permit standard variation as would be understood by those of ordinary skill in the art. Where ranges are provided herein, the endpoints are included. Any numerals used in this application with or without about/approximately are meant to cover any normal fluctuations appreciated by one of ordinary skill in the relevant art. In some embodiments, the term “approximately” or “about” refers to a range of values that fall within 25%, 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value).

Polymer: As used herein, the term “polymer” generally refers to a substance that has a molecular structure consisting chiefly or entirely of repeated sub-units bonded together, such as synthetic organic materials used as plastics and resins.

Substantially: As used herein, the term “substantially” refers to the qualitative condition of exhibiting total or near-total extent or degree of a characteristic or property of interest.

### BRIEF DESCRIPTION OF THE DRAWINGS

Drawings are presented herein for illustration purposes, not for limitation. The foregoing and other objects, aspects, features, and advantages of the disclosure will become more apparent and may be better understood by referring to the following description taken in conjunction with the accompanying drawings, in which:

FIG. 1 is a scanning electron microscopy (SEM) micrograph of a structured conversion cathode, according to illustrative embodiments of the present disclosure;

FIGS. 2A-2D are cross sectional schematics of structured conversion cathodes, according to illustrative embodiments of the present disclosure;

FIG. 3 is a flow chart of a method for forming a structured conversion cathode, according to illustrative embodiments of the present disclosure;

FIG. 4 is a cross sectional representation of an electrochemical cell, according to illustrative embodiments of the present disclosure;

FIG. 5 is a cross sectional representation of an electrochemical cell, according to illustrative embodiments of the present disclosure;

FIG. 6 is a perspective representation of a cylindrical battery, according to illustrative embodiments of the present disclosure;

FIG. 7 is a perspective representation of a coin cell assembly, according to illustrative embodiments of the present disclosure; and

FIGS. 8A-23C are SEM micrographs of constructed examples of structured conversion cathodes, according to illustrative embodiments of the present disclosure.

Schematics are not necessarily drawn to scale.

### DETAILED DESCRIPTION OF CERTAIN EMBODIMENTS

Described herein are, among other things, structured cathodes for use in electrochemical cells (e.g., batteries, such as secondary batteries), electrochemical cells (e.g., batteries) including such cathodes, and methods for their formation and use. A structured cathode includes at least one electrochemically active material. An electrochemically active material may be an electrochemically active conversion material. An example of an electrochemically active conversion is a sulfur-based material in a lithium-sulfur battery. The electrochemically active conversion material may be included in a patterned film. A patterned film including one or more electrochemically active materials may be disposed on a substrate (e.g., current collector) (e.g., on which the film was formed) or may be free standing. A patterned film is one having at least one patterned surface, for example having recesses extending into the film (e.g., in a direction substantially perpendicular to a surface of a film). A patterned film may be porous. A patterned film may be made of an assembly of particles including an electrochemically active material (e.g., a conversion material). A method of using a structured cathode may include expanding a film during electrochemical cycling of an electrochemical cell (e.g., a battery) such that a portion of an electrolyte in the cell is displaced from the bulk of the film into recesses extending into the film. A method of making a structured cathode may include providing (e.g., forming) a film that includes electrochemically active conversion material and forming recesses in a surface of the film that extend into the film. Forming the recesses may occur by removing material from the film, for example by laser ablation.

### Structured Cathodes

In some embodiments, a cathode includes a film including an electrochemically active material and a substrate (e.g., current collector). The electrochemically active material may be a conversion material. The film has a first surface in contact with the substrate (e.g., current collector) and a second surface on a side of the film opposite the first surface (e.g., not in contact with the substrate. The second surface is patterned such that it includes recesses that extend into the film towards the substrate. The recesses may extend all the way to the substrate (extend entirely through the film) or may extend only part of the distance from the surface to the substrate, or a combination thereof. The recesses may include holes, trenches (e.g., wells, troughs, channels, or a combination thereof), or both. Holes may be substantially circular in cross section (which is generally the case when formed by laser ablation since laser beams are usually circular). Trenches may have a substantially rectangular cross section, or a “U” shaped cross section. Trenches may have a length across a patterned surface that is much greater than a width of the trenches, a depth of the trenches, or both. Recesses may be at least partially filled with electrolyte, for example a liquid, gel, or polymer electrolyte. In some embodiments, recesses are filled with solid electrolyte. The substrate may be electrically conductive, such as is the case for a current collector.

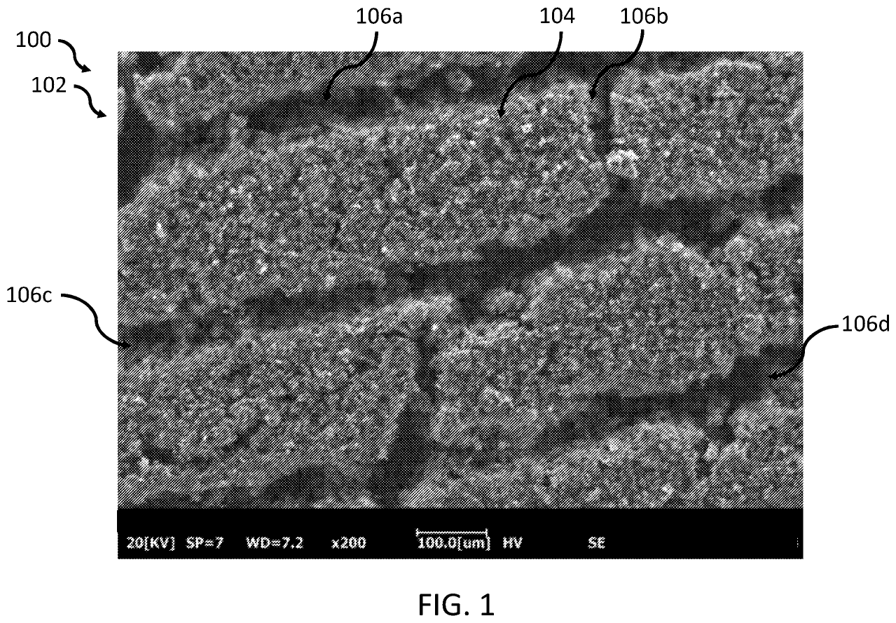

FIG. 1 is an SEM micrograph showing a top-down view of the surface of a cathode 100, a cathode according to illustrative embodiments of the present disclosure. Cathode 100 includes cathode film 102, which is a patterned film. Cathode film 102 has a patterned second surface (shown) and an unpatterned first surface (not shown), which is opposite the second surface and in contact with a current collector (not shown). Patterned second surface of film 102 includes recesses that are trenches, including trenches 106a-d. Trenches 106a-d are interconnected, for example trench 106a is directly interconnected with trench 106b and trench 106c is interconnected with trench 106a via trench 106b. Trenches 106a-d do not extend all the way through (extend only partially into) film 102. Film 102 also includes uppermost portions 104. Film 102 is an assembly of particles each including electrochemically active conversion material (e.g., sulfur), such as core-shell or yolk-shell particles. Film 102 may include additional components such as binder and/or one or more conductive additives.

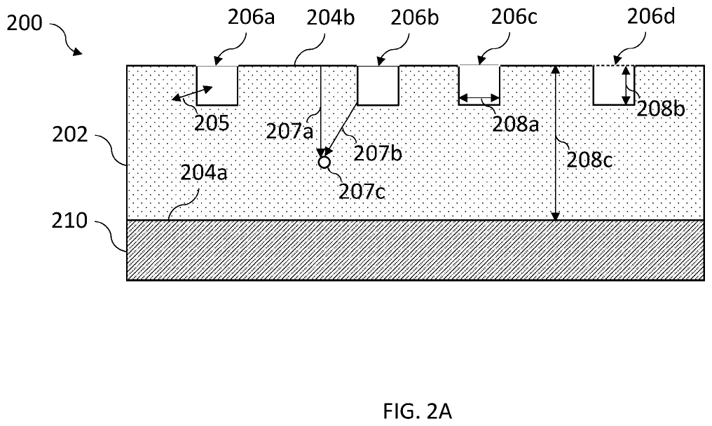

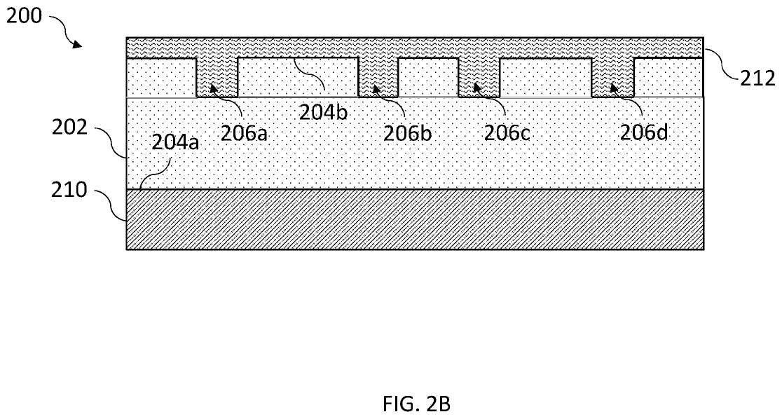

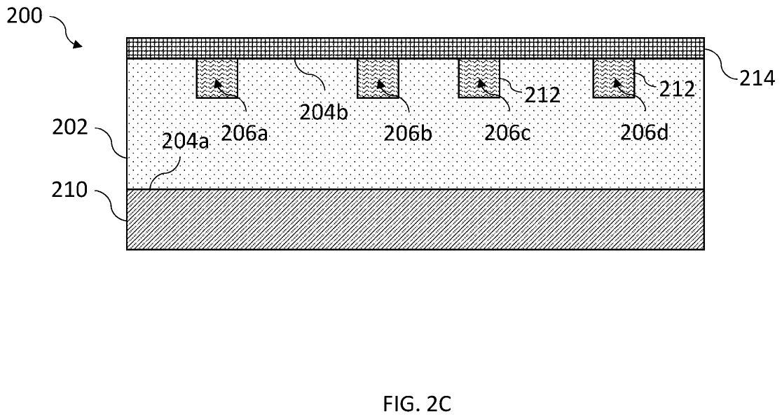

FIG. 2A is a cross sectional representation that illustrates embodiments of the present disclosure. FIG. 2A shows cathode 200 that includes patterned film 202, including electrochemically active conversion material, disposed (e.g., formed) on current collector 210. Patterned film 202 includes unpatterned first surface 204a, disposed on current collector 210, and patterned second surface 204b. Patterned second surface 204b includes uppermost portions and recesses 206a-d that extend into film 202. Recesses 206a-d have at least two substantially uniform dimensions (if trenches, the in/out of paper dimension may vary) but, in general, recesses need not be of substantially uniform size. Specifically, recesses 206a-d have at least a substantially uniform width 208a and depth 208b. (In other embodiments, the width and/or depth of different recesses may not be uniform.) If recesses 206a-d include one or more holes, the one or more holes may be substantially circular in cross section and characterized by a diameter corresponding to width 208a. If recesses 206a-d include one or more trenches, the one or more trenches may have substantially the same lengths or different lengths (e.g., as shown in FIG. 1 where the generally side-to-side trenches, like trench 106c, are longer than the generally top-to-bottom trenches, like trench 106b). Recesses 206a-d are not uniformly distributed across second surface 204b as seen from the uneven spacing. In some embodiments, recesses 206a-d may be disposed uniformly (e.g., in one or two dimensions). Film 200 may (or may not) be made of an assembly of particles each including electrochemically active material (e.g., core-shell or yolk-shell particles). Film 202 may be porous (e.g., if an assembly of particles).

When incorporated into an electrochemical cell (e.g., battery) that includes an electrolyte, recesses 206a-d may act as local reservoir locations for electrolyte that flows into and out of bulk of cathode film 202 during electrochemical cycling, as indicated by arrows 205. Film 202 has a maximal thickness as shown by 208c. Recesses 206a-d do not extend through an entire (maximal) thickness of film 202. Due to presence of recesses 206a-d, an average (or maximal) mass transport path into may be less than for an unpatterned film, as approximately represented by arrows 207a-b pointing to circular region 207c of film 202, where arrow 207b is shorter than arrow 207a due to recess 206b.

FIG. 2B shows illustrates similar embodiments to FIG. 2A with electrolyte 212 present. Electrolyte 212 at least partially fills (in this case entirely fills) recesses 206a-d. Electrolyte 212 may be a liquid, gel, polymer, or solid. A separator and anode (e.g., lithium anode) or anode-free configuration (e.g., current collector on which lithium deposits in situ) may be added (e.g., along with one or more other components) to form a complete electrochemical cell. FIG. 2C illustrates mixed electrolyte embodiments where solid electrolyte 214 (e.g., directly) contacts patterned second surface 204b (at its uppermost portions) while recesses 206a-d are at least partially filled with liquid, gel, or polymer electrolyte 212. FIG. 2D illustrates separator 216 disposed on (e.g., in contact with) patterned second surface 204b (at its uppermost portions) while recesses 206a-d are at least partially filled with electrolyte 212. In some embodiments, an interlayer of insoluble products forms where separator 216 contacts film 202.

Recesses may be disposed in a regular or irregular pattern across a cathode film. For example, recesses may be disposed in a regular one- or two-dimensional array or disposed in a random pattern. A patterned surface of a film may have a repeating geometric pattern of recesses, for example conforming to a hexagonal grid (e.g., a hexagonal close-packed arrangement), an isometric grid, or a square grid. Ones of the recesses may be interconnected across a patterned surface of a film, for example trenches may intersect each other, trenches may intersect holes, or both. Interconnected recesses may form a network across an extent of a patterned surface. Recesses may extend all the way through a cathode film (e.g., down to a substrate such as a current collector) or only partially into a cathode film.

Recesses may have a length, a width, and a depth. If recesses are holes, length and width dimensions of each hole may be substantially the same—each a diameter of the hole. In some embodiments, a diameter of holes extending into a film corresponds to a resolution limit of a pulsed laser (e.g., at least about 20 nm). In certain embodiments, a diameter of holes extending into a film is within the range of about 20 nm to about 500 μm (e.g., 20 nm to 50 μm, 20 nm to 100 μm, 20 nm to 200 μm, 20 nm to 300 μm, 100 nm to 100 μm, 100 nm to 200 μm, 1 μm to 100 μm, 1 μm to 200 μm, 10 μm to 100 μm, 10 μm to 200 μm, 50 μm to 100 μm, 50 μm to 200 μm, or 100 μm to 200 μm). If recesses are trenches, length and width may be different. For example, width may be 20 nm to 500 μm (e.g., 20 nm to 50 μm, 20 nm to 100 μm, 20 nm to 200 μm, 20 nm to 300 μm, 100 nm to 100 μm, 100 nm to 200 μm, 1 μm to 100 μm, 1 μm to 200 μm, 10 μm to 100 μm, 10 μm to 200 μm, 50 μm to 100 μm, 50 μm to 200 μm, or 100 μm to 200 μm) and length may be different (e.g., at least 100 nm, at least 1 μm, at least 10 μm, at least 50 μm, at least 100 μm, at least 250 μm, at least 500 μm, at least 750 μm, or at least 1 mm). In some embodiments, at least some recesses have at least one (e.g., a width, a depth, or a width and a depth) dimension that is in a range of from 20 nm to 500 μm (e.g., from 100 nm to 200 μm or from 50 nm to 100 μm). In some embodiments, at least some recesses have a length of at least 100 μm (e.g., at least 200 μm, at least 500 μm, or at least 1 mm) (e.g., and others of the recesses have a length of at least 50 μm, at least 100 μm, at least 200 μm or at least 500 μm). A spacing between at least some (e.g., all) pairs of adjacent recesses (e.g., if disposed in a regular one- or two-dimensional array across a patterned surface) may be at least 20 μm (e.g., at least 50 μm, at least 75 μm, at least 100 μm, at least 150 μm, at least 200 μm, or at least 250 μm). Recesses may be microstructures (each a microstructure).

In some embodiments, recesses have one or more vertical walls (whether holes or trenches). In some embodiments, recesses are sloped so that at least one dimension of the recesses narrows with distance extending into a cathode film. In some embodiments, recesses each have a depth that is at least 25% of a maximal thickness of a cathode film. For example, ones of recesses may have a depth extending into a cathode film that is at least 25% of a maximal thickness of the film (e.g., at least 50%, at least 75%, at least 80% or at least 90% of the thickness). Ones of recesses may extend through a patterned surface (e.g., down to a current collector). In some embodiments, a film is discontinuous (e.g., recesses define one or more islands each including electrochemically active material a portion of an assembly of individual structures). In some embodiments, a cathode film is continuous (e.g., a portion of the film is disposed under each recess). In some embodiments, at least some recesses extend entirely through a film (e.g., down to a substrate, such as a current collector, on which the film is disposed). In some embodiments, no recess extends entirely through a film. A cathode film may have a linear density of recesses of at least 2/mm (e.g., at least 4/mm, at least 5/mm, at least 6/mm, at least 8/mm, or at least 10/mm) across at least one direction. A cathode film may have an areal density of recesses of at least 5/mm² (e.g., at least 6/mm², at least 8/mm², at least 10/mm², at least 15/mm², or at least 20/mm²) (e.g., measured in a plane across the film with maximal presence of recesses, such as once coincident with uppermost portions of a patterned second surface). A cathode film may have both such a linear density and such an areal density.

A film of a cathode may be porous (e.g., before and/or after calendering). In some embodiments, a film has been heavily calendered such that it has little to no remaining porosity, for example no more than 40% (e.g., no more than 30%, no more than 20%, or no more than 10%) of an initial porosity before calendering. Change in porosity may also be measured using comparison of initial film thickness before calendering with film thickness after calendering (e.g., and before patterning), for example thickness may decrease to no more than 40% (e.g., no more than 30%, no more than 20%, or no more than 10%) of an initial thickness. An initial thickness may be, for example, no more than 1 mm (e.g., no more than 500 μm) and a final thickness after calendering may be no more than 200 μm (e.g., no more than 100 μm, no more than 50 μm, no more than 25 μm, or no more than 20 μm). In some embodiments, a film is a porous assembly of individual structures (e.g., nanostructures) that include an electrochemically active material (e.g., a conversion material). The individual structures may be or include particles (e.g., nanoparticles), fibers (e.g., nanofibers), rods (e.g., nanorods), or a combination thereof. In some embodiments, individual structures have at least one dimension (e.g. a diameter, a length, a width, a height, or a combination thereof) of no more than 500 nm (e.g., no more than 250 nm, no more than 100 nm, or no more than 50 nm). In some embodiments, structures include core-shell particles (e.g., nanoparticles) having cores of electrochemically active material or yolk-shell particles (e.g., nanoparticles) having yolks of electrochemically active material. The shell of the core-shell particles or the yolk-shell particles may be selectively permeable. A film that is a porous assembly of individual structures may further include a conductive additive and/or binder (e.g., polymer binder) interspersed in the assembly (e.g., that promotes electron transfer through the assembly and/or binds the individual structures together, respectively). A cathode may be substantially devoid of carbon (e.g., no more than 10 wt % carbon, no more than 5 wt % carbon, no more than 2 wt % carbon, or no more than 1 wt % carbon).

An electrochemically active material in a cathode may be or include a chalcogenide (e.g., S, Se, and/or Te). An electrochemically active material may be an electrochemically active conversion material (e.g., S₈). An electrochemically active conversion material may be or include (i) sulfur in its S₈ cyclic octatomic molecular form, (ii) sulfur in the form of a lithium sulfide (e.g., Li₂S₂ and/or Li₂S), (iii) sulfur in the form of an electrochemically active organosulfur compound, (iv) sulfur in the form of an electrochemically active sulfur-containing polymer [e.g., carbon-sulfur polymers ((C₂Sₓ) n where x=2.5 to 50 and n≥2)], or (v) a combination of any two or more of (i)-(iv). In some embodiments, an electrochemically active material includes a metal sulfide. In some embodiments, an electrochemically active material is an intercalation material. In some embodiments, a cathode film includes an intercalation material, for example an electrochemically active intercalation material. In some embodiments, a cathode film further includes one or more metal sulfides in addition to a first electrochemically active material. A film may include a conductive additive (e.g., conductive carbon), a binder (e.g., polymer binder), or both. In certain embodiments, an electrochemically active intercalation material includes one or more components selected from the group consisting of metal oxides, metal sulfides, metal phosphates, metal selenides, and mixtures and combinations thereof. In certain embodiments, an electrochemically active intercalation material (e.g., for lithium ions) includes one or more metal sulfides. In certain embodiments, a metal sulfide is selected from the group consisting of vanadium sulfide (e.g., VS₂), molybdenum sulfide (e.g., MoS₂ and/or Mo₆S₈), and titanium sulfide (e.g., TiS₂). In certain embodiments, a metal sulfide is selected from the group consisting of VS₂, MoS₂, Mo₆S₈, and TiS₂. In certain embodiments, a metal sulfide is TiS₂. In certain embodiments, a metal sulfide is Mo₆S₈.

Recesses may be distributed across a patterned surface of a film such that no point within the film (e.g., in bulk of the film) is more than 500 μm (e.g., more than 200 μm, more than 100 μm, more than 50 μm, more than 25 μm, or more than 20 μm) from at least one edge of at least one of the recesses. In some embodiments, recesses are distributed across a patterned surface of a film such that any point within the film is within a distance of a closest one of the recesses that is no more than three times (e.g., no more than twice, no more than 1.5×, or no more than) a maximum thickness of the film. Maximum thickness may be the minimum straight line distance between an uppermost portion of a patterned surface of a film and an opposing surface of the film (e.g., that contacts a substrate) (e.g., as in arrows 208c in FIG. 2A). Recesses may represent at least 5% (e.g., at least 10%, at least 15%, at least 20%, at least 25%, at least 33% or at least 50%) of total volume contained between a plane coincident with an uppermost portion of a patterned surface of a film and an opposing surface (e.g., that is unpatterned) (e.g., in contact with a current collector).

In some embodiments, a total volume of recesses corresponds (e.g., is matched) to an expected volume of electrolyte displaced from bulk of a cathode during electrochemical cycling (e.g. upon full discharge of the electroactive material contained in the cathode). The expected volume of electrolyte that will be displaced can be estimated empirically or calculated numerically. In this way, the recesses may act as local reservoirs to prevent permanent loss of electrolyte (e.g., to an outer perimeter of an electrochemical cell) and/or detrimental effects of pressure build up and/or electrochemical cell swelling that may otherwise be caused by electrochemical cycling, independent of any benefit that may be achieved in terms of reduced average mass transport pathway into the cathode (e.g., bulk of the cathode). Thus, in some embodiments, recesses are more filled with electrolyte during one stage of electrochemical cycling than during another stage. For example, in a lithium-sulfur battery where sulfur is an electrochemically active conversion material in a cathode film, sulfur converts to a lithium sulfide during discharge and undergoes volume expansion, which can displace electrolyte. If a surface of the cathode film is patterned, then electrolyte can displace into recesses into the patterned surface.

In some embodiments, surfaces of recesses extending into a film (e.g., portions of a patterned surface defined by the recesses) are coated with a solid material having a composition different from composition of bulk cathode in the film. The surfaces of the recesses may be coated with a solid epitaxial material (e.g., formed by atomic layer deposition after formation of the recesses).

A patterned film may be disposed (e.g., formed) on a substrate (e.g., current collector). In some embodiments, a respective film is disposed on each of two opposing sides of a substrate (e.g., current collector) and, optionally, one or both of the films may have a patterned surface with recesses extending into the film. A substrate on which one or more films are disposed may be porous. Recesses in a patterned film disposed on a porous substrate may extend entirely through the film such that they intersect with pores in the substrate (e.g., that extend entirely through the substrate). In some embodiments, recesses in each respective patterned film disposed on opposing sides of a porous substrate may extend entirely through the film such that they mutually intersect with pores through the substrate thereby defining pores entirely through the cathode (e.g., for free flow of a liquid electrolyte).

In some embodiments, a film has been patterned after the film has been applied to a substrate (e.g., current collector). In some embodiments, a film has been produced by applying a wet slurry to a substrate and subsequently drying the slurry prior to patterning. In some embodiments, a film has been calendered prior to patterning a surface of the film. In some embodiments, a surface of a film has been patterned by laser ablation. Patterning by laser ablation may use a pulsed laser. The pulsed laser may have applied pulses of a duration of no more than 1000 femtoseconds (e.g., no more than 500, 400, 300, 200, 150, 100, 50, 25, 15, 10, 5, 4, 3, 2, or 1 fs). Laser ablation is an attractive process for patterning a surface of a film because experiments have shown that morphology and porosity and can be substantially preserved near recesses formed in the film when patterning (see Examples below).

In some embodiments, an average mass transport path to electrochemically active material in a structured cathode (e.g. a cathode comprising a patterned film) is shorter than an average mass transport path to electrochemically active material in an otherwise equivalent cathode without the recesses (e.g. a cathode comprising an unpatterned or smooth film). Likewise, in some embodiments, alternatively or additionally, a tortuosity of a structured cathode is reduced compared to a tortuosity of an otherwise equivalent cathode without the recesses. In some embodiments, a capacity of a structured cathode is greater than a capacity of an otherwise equivalent cathode without recesses at a same current density, for example due to higher utilization of electrochemically active material in bulk during electrochemical cycling. For example, a capacity of a structured cathode may be at least 5% greater (e.g., at least 10% greater, at least 20% greater, at least 30% greater, or more) than an otherwise equivalent cathode at a same cycling rate (current density). In some embodiments, a cathode has a high volumetric capacity. Actual volumetric capacity may depend on cycling rate, electrode thickness, temperature, electrolyte chemistry, or a combination thereof.

A film may include only one layer of material or may include multiple layers. Individual structures assembled into a porous film may be of only one type (e.g., core-shell or yolk-shell particles that include cores or yolks, respectively, of electrochemically active material, such as conversion material) or of multiple types (e.g., a mixture of one or more electrochemically active intercalation materials and one or more electrochemically active conversion materials). A multilayer structure may include discrete layers of different electrochemically active materials, for example an electrochemically active intercalation material layer on an electrochemically active conversion material layer or vice versa. Recesses in a patterned surface of a multilayer film may extend in to only one of the multiple layers or may extend into more than one of the multiple layers. Thus, an advantage may be realized in drastically shortening a length of a mass transport path to one or more layers in a multilayer structure that are not surface layer(s) (e.g., an electrochemically active intercalation material layer covered by an electrochemically active conversion material layer). One or more layers (e.g., each layer) of a multilayer cathode film may be porous.

In certain embodiments, a substrate (e.g. a current collector) includes a component selected from a metal foil, a metallized polymer film, and a carbon composition. In some embodiments, a current collector includes aluminum foil, copper foil, nickel foil, stainless steel foil, titanium foil, zirconium foil, molybdenum foil, nickel foam, copper foam, carbon paper or fiber sheets, polymer substrates coated with conductive metal, and/or combinations thereof. In certain embodiments, a current collector includes a metal foil. In certain embodiments, a current collector includes a metallized polymer film. In certain embodiments, a current collector includes a carbon composition. In certain embodiments, a cathode includes a conductive carbon coating between a current collector and a second active layer including a lithium ion intercalation active material.

In certain embodiments, a cathode film includes an electrically conductive additive that facilitates movement of electrons within a cathode. For example, in certain embodiments, a conductive additive is selected from the group consisting of carbon-based materials, graphite-based materials, conductive polymers, metal salts, oxides, or chalcogenides, and combinations thereof. In certain embodiments, a conductive additive includes a carbon-based material. In certain embodiments, a conductive additive includes a graphite-based material. For example, in certain embodiments, an electrically conductive additive is selected from the group consisting of conductive carbon powders, such as carbon black, Super PR, C-NERGY™ Super C65, Ensaco® black, Kctjenblack®, acetylene black, synthetic graphite such as Timrex® SFG-6, Timrex® SFG-15, Timrex® SFG-44, Timrex® KS-6, Timrex® KS-15, Timrex® KS-44, natural flake graphite, graphene, graphene oxide, carbon nanotubes, fullerenes, hard carbon, mesocarbon microbeads, and the like. In certain embodiments, a conductive additive includes one or more conductive polymers. For example, in certain embodiments, a conductive polymer is selected from the group consisting of polyaniline, polythiophene, polyacetylene, polypyrrole, and the like. In certain embodiments, a single conductive additive is used alone. In some embodiments, a multiple conductive additives are used together.

In certain embodiments, a cathode includes a binder (e.g., a substance that binds individual structures (e.g., particles) together and/or adheres individual structures to a substrate, such as a current collector). Typical binders include polyvinylidene fluoride (PVDF), poly(vinylidene fluoride-co-hexafluoropropene) (PVDF/HFP), Polytetrafluoroethylene (PTFE), Kynar Flex® 2801, Kynar® Powerflex LBG, Kynar® HSV 900, Teflon®, carboxymethylcellulose, styrene-butadiene rubber (SBR), polyethylene oxide, polypropylene oxide, polyethylene, polypropylene, polyacrylates, polyvinyl pyrrolidone, poly(methyl methacrylate), polyethyl acrylate, polytetrafluoroethylene, polyvinyl chloride, polyacrylonitrile, polycaprolactam, polyethylene terephthalate, polybutadiene, polyisoprene or polyacrylic acid, or derivatives, mixtures, or copolymers of any of these. In some embodiments, a binder is water soluble binder, such as sodium alginate or carboxymethyl cellulose. Generally, binders hold the active materials together and in contact with a current collector (e.g., aluminum foil or copper foil). In certain embodiments, a binder is selected from the group consisting of poly(vinyl acetate), polyvinyl alcohol, polyethylene oxide, polyvinyl pyrrolidone, alkylated polyethylene oxide, crosslinked polyethylene oxide, polyvinyl ether, poly(methyl methacrylate), polyvinylidene fluoride, a copolymer of polyhexafluoropropylene and polyvinylidene fluoride, polyethyl acrylate, polytetrafluoroethylene, polyvinyl chloride, polyacrylonitrile, polyvinyl pyridine, polystyrene, and derivatives, mixtures, and copolymers thereof.

In certain embodiments, a cathode further includes a coating layer. For example, in certain embodiments, a coating layer includes a polymer, an inorganic material, or a mixture thereof. In certain such embodiments, a polymer is selected from the group consisting of polyvinylidene fluoride, a copolymer of polyvinylidene fluoride and hexafluoropropylene, poly(vinyl acetate), poly(vinyl butyral-co-vinyl alcohol-co-vinyl acetate), poly(methylmethacrylate-co-ethyl acrylate), polyacrylonitrile, polyvinyl chloride-co-vinyl acetate, polyvinyl alcohol, poly(l-vinylpyrrolidone-co-vinyl acetate), cellulose acetate, polyvinyl pyrrolidone, polyacrylate, polymethacrylate, polyolefin, polyurethane, polyvinyl ether, acrylonitrile-butadiene rubber, styrene-butadiene rubber, acrylonitrile-butadiene styrene, a sulfonated styrene/ethylene-butylene/styrene triblock copolymer, polyethylene oxide, and derivatives, mixtures, and copolymers thereof. In certain such embodiments, an inorganic material includes, for example, colloidal silica, amorphous silica, surface-treated silica, colloidal alumina, amorphous alumina, tin oxide, titanium oxide, titanium sulfide (TiS₂), vanadium oxide, zirconium oxide (ZrO₂), iron oxide, iron sulfide (FeS), iron titanate (FeTiO₃), barium titanate (BaTiO₃), and combinations thereof. In certain embodiments, an organic material includes conductive carbon. In certain embodiments, an organic material includes graphene, graphene nitride, or graphene oxide.

In certain embodiments, precursors for the provided structured cathodes can be formulated without a binder, which can be added during manufacture of cathode films (e.g. dissolved in a solvent used to form a slurry from a provided mixture). In embodiments where binders are included in a provided cathode film, a binder can be activated when a mixture is made into a slurry to manufacture cathode films.

Suitable materials for use in the provided structured cathodes include those disclosed in Cathode Materials for Lithium Sulfur Batteries: Design, Synthesis, and Electrochemical Performance, Lianfeng, et al., Interchopen.com, published June 1st 2016, and The Strategies of Advanced Cathode Composites for Lithium-Sulfur Batteries, Zhou et al., SCIENCE CHINA Technological Sciences, Volume 60, Issue 2:175-185 (2017), the entire disclosures of each of which are hereby incorporated by reference herein.

### Methods of Making Structured Cathodes

Structured cathodes may be formed using appropriately adapted conventional processes for mass manufacturing of cathodes. For example, many cathodes are made using roll-to-roll processing. One or more additional steps may be added to a roll-to-roll process, or another process or processes, to form a structured cathode. As one example, slot-die coating with an appropriately shaped die could form certain recesses in a cathode film as it was coated, for example parallel trenches of variable depth. In general, a method of making a structured cathode includes providing (e.g., forming) a film comprising electrochemically active material (e.g., conversion material) and forming recesses in a surface of the film that extend into the film (e.g., only partially or entirely through the film). The recesses and film may be formed simultaneously (e.g., as the case may be for slot-die coating) or the recesses may be formed after the film is produced. An initial film may be formed (e.g., by slot-die coating) (e.g., on a substrate, such as a current collector) and then calendered. In some embodiments, recesses are formed in a film, to form a patterned surface of the film, only after calendering has occurred. Recesses may be formed by removing material from the film, or by rearranging material in the film (e.g., by debossing, such as, for example, compacting, stamping, and/or imprinting) portions of the film, by patternwise deposition of material (e.g., using a special slot or die), or by any combination thereof. Laser ablation is a preferred approach for forming recesses.

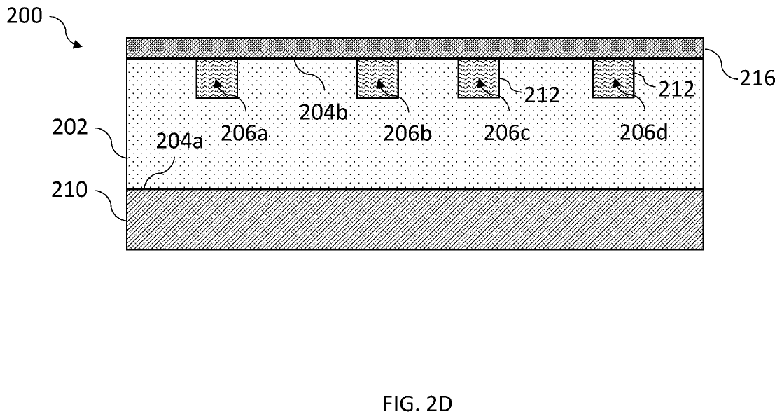

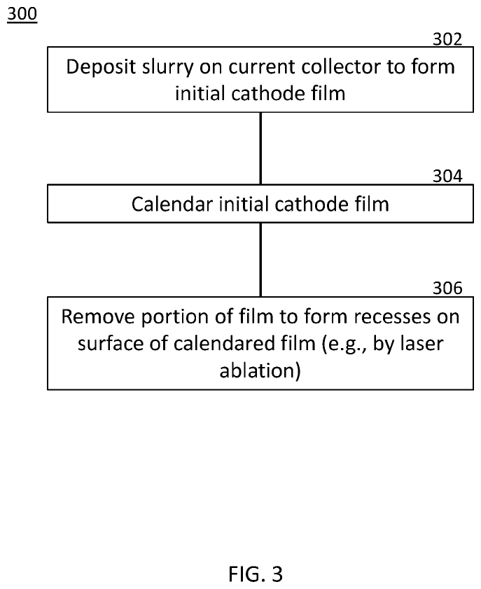

FIG. 3 is a flow chart for method 300, which is in accordance with illustrative embodiments of the present disclosure. In step 302, a slurry is deposited (e.g., by slot-die coating) onto a current collector to form an initial cathode film. In step 304, the initial cathode film is calendered. Calendering may be “heavy”-substantially reducing initial porosity in the film. For example, where slurry includes individual structures (e.g., nanostructures), such as particles, rods, fibers, or a combination thereof, calendering may compact the structures significantly as compared to the initial deposition thereby reducing porosity. In step 306, a portion of the calendered film is removed to form recesses on a surface of the film. Laser ablation may be used to perform the removal.

Recesses may be formed in a film (e.g., that has already been calendered) by laser ablation. Laser ablation generally will act to remove material from the film. Laser ablation is desirable in part because it is highly controllable. Pulsed lasers may be used to precisely control ablation. In some embodiments, a pulsed laser applies pulses of a duration of less than 1000 femtoseconds (e.g., less than 500, 400, 300, 200, 150, 100, 50, 25, 15, 10, 5, 4, 3, 2, or 1 fs) to a film (e.g., an already calendered film).

Recess formation, for example by laser ablation, may be performed in-line (e.g., during fabrication of a battery). That is, in certain embodiments, conventional cathode productions lines can be modified to pattern cathode film surfaces with recesses without the need for significant retooling. For example, in some embodiments, a laser ablation device is simply added at the appropriate location in a roll-to-roll production process to form recesses on cathode film surfaces during battery manufacturing.

In some embodiments, a film that is provided (e.g., formed) is calendered. The film may be calendered on a substrate (e.g., current collector). The substrate may be porous. Different films may be calendered onto different sides of the substrate (e.g., one on each of two opposing sides). If two such films are present, then each may have a patterned surface, for example by applying laser ablation to both sides. Forming of recesses may occur only after calendering of an initial film. In this way, detrimental changes to morphology or size of recesses that may otherwise be caused by calendering a cathode film can be avoided. Calendering may be applied to such an extent as to leave no more than 40% (e.g., no more than 30%, no more than 20%, or no more than 10%) of an initial porosity present in a cathode film before calendering. Alternatively or additionally, calendering may make a maximum thickness of a cathode film no more than 40% (e.g., no more than 30%, no more than 20%, or no more than 10%) of an initial thickness before calendering.

In some embodiments, forming recesses in a cathode film comprises removing material (e.g., electrochemically active material, and, if present, binder and/or conductive additive). Removing material may include laser ablation of the material. Removing material may include scraping, cutting, and/or scratching (e.g., with one or more blades). In some embodiments, forming recesses in a cathode film includes debossing (e.g., compacting, stamping and/or imprinting) the film.

In some embodiments providing a cathode film comprises forming the film. Forming a cathode film may include assembling individual structures (e.g., particles, such as nanoparticles) that include electrochemically active material, such as a conversion material for example. Such an assembly may be cast from a slurry. The assembling may include one or more of slurry coating, slot-die coating, spin coating, spray drying, draw-down coating, doctor-blade coating, inkjet printing, comma-coating, and reverse comma-coating. The initial assembly may be porous (e.g., highly porous) and may maintain some porosity after calendering.

### Electrochemical Cells

In some embodiments, a structured cathode disclosed herein is included in an electrochemical cell. An electrochemical cell may be a battery, such as a secondary battery. A cathode included in a battery may be a conversion cathode, including electrochemically active conversion material, such as in a lithium-sulfur battery or sodium-sulfur battery. In some embodiments, an electrochemical cell includes a structured cathode disclosed herein, an electrolyte, an anode, and optionally a separator. A structured cathode may be porous such that electrolyte can be disposed in bulk of a cathode film where recesses of a patterned surface of the film provide local reservoirs for portions of the electrolyte displaced from the bulk of the film during electrochemical cycling. An electrolyte may at least partially fill recesses in a film of a structured cathode. The electrolyte may be liquid, gel, polymer, or solid. An electrolyte may also directly contact a patterned surface of a film, for example where not recessed. A battery may include a solid, polymer, or gel electrolyte (e.g., polymer gel electrolyte) that at least partially fills recesses in a patterned surface of a structured cathode. A battery may include a liquid electrolyte that at least partially fills recesses in a patterned surface of a structured cathode. A battery may include mixed electrolytes, such as a solid electrolyte and a liquid electrolyte. For example, liquid electrolyte may at least partially fill recesses in a patterned surface of a cathode film and solid electrolyte may contact the patterned surface (e.g., at least at non-recessed portions of the patterned surface). Such a battery can exploit benefits of both solid and liquid electrolytes at once.

In some embodiments, a battery includes a non-conductive separator that contacts a patterned surface of a cathode film (e.g., at non-recessed portions of the film). Such contact may thereby define a separator-cathode interface. One or more insoluble products (e.g., non-equilibrium insoluble products) may be disposed (e.g., precipitated) at a higher concentration on the patterned surface of the film at the separator-cathode interface than in recesses in the patterned surface. The recesses that are not in contact with non-conductive separator may be substantially devoid of insoluble products.

In some embodiments, a battery includes a protected lithium metal anode that is in contact with a structured cathode disclosed herein. In some embodiments, a battery has an anode-free configuration (e.g., wherein lithium deposits on a current collector during a first electrochemical cycle).

Structured cathodes disclosed herein may be used with an electrolyte that does not include a sulfonamide salt (e.g., LiTFSI), thereby achieving lower cost by avoiding expensive electrolytes that may otherwise be needed to achieve high performance. In some embodiments, a battery has a low (e.g., extremely low) electrolyte to sulfur (E/S) ratio, for example no more than 10, no more than 7, no more than 5, no more than 3, or lower than 3.

The present disclosure provides secondary sulfur batteries including cathodes and compositions described herein. In certain embodiments, such batteries include a lithium-containing anode composition coupled to the provided cathode composition by a lithium conducting electrolyte. In some embodiments, such batteries also include additional components such as separators between the anode and cathode, anodic and cathodic current collectors, terminals by which a cell can be coupled to an external load, and packaging such as a flexible pouch or a rigid metal container. In some embodiments, the present disclosure is directed to a lithium-sulfur battery including a sulfur-containing cathode, a lithium-containing anode, and an electrolyte ionically coupling the anode and cathode. It is further contemplated that the present disclosure regarding secondary sulfur batteries can be adapted for use in sodium-sulfur batteries, and such batteries are also considered within the scope of certain embodiments of the present disclosure.

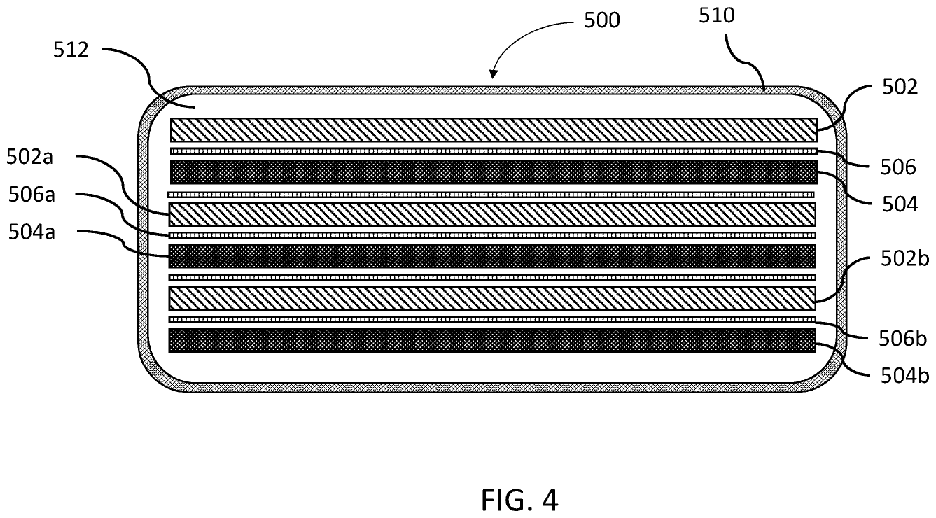

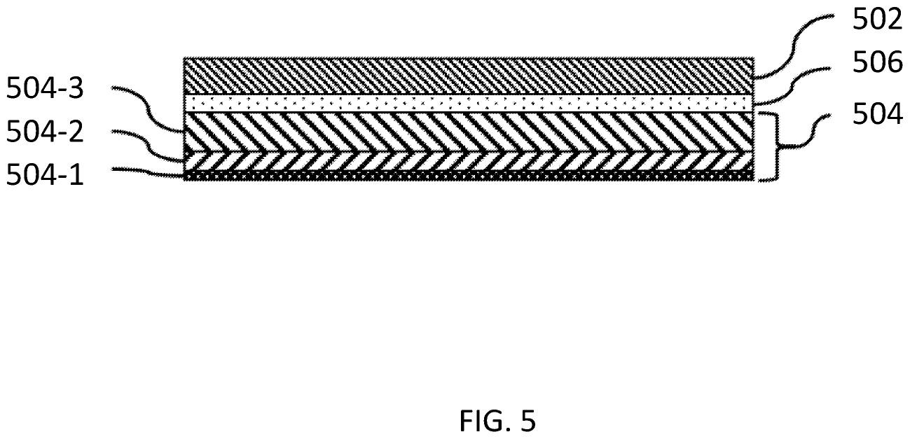

FIG. 4 illustrates a cross section of an electrochemical cell 500 in accordance with exemplary embodiments of the disclosure. Electrochemical cell 500 includes a negative electrode 502, a positive electrode 504, a separator 506 interposed between negative electrode 502 and positive electrode 504, a container 510, and a fluid electrolyte 512 in contact with negative and positive electrodes 502, and 504 respectively. Such cells optionally include additional layers of electrode and separators 502a, 502b, 504a, 504b, 506a, and 506b. FIG. 5 illustrates another view of a cross section through a representative cell stack showing the negative electrode 502, a positive electrode 504, and a separator 506 interposed between the negative electrode 502 and positive electrode 504. FIG. 5 also shows the layers including the electrode 504. Specifically, the layers include current collector 504-1, cathode layer 504-2 including a lithium intercalation active material and cathode layer 504-3 including a conversion active material. As shown, the lithium intercalation active material 504-2 is interposed between current collector 504-1 and cathode layer 504-3.

Negative electrode 502 (also sometimes referred to herein as an anode) includes a negative electrode active material that can accept cations. Non-limiting examples of negative electrode active materials for lithium-based electrochemical cells include Li metal, Li alloys such as those of Si, Sn, Bi, In, and/or Al alloys, Li₄Ti₅O₁₂, hard carbon, graphitic carbon, metal chalcogenides, and/or amorphous carbon. In accordance with some embodiments of the disclosure, most (e.g., greater than 90 wt %) of an anode active material can be initially included in a discharged positive electrode 504 (also sometimes referred to herein as a cathode) when electrochemical cell 500 is initially made, so that an electrode active material forms part of first electrode 502 during a first charge of electrochemical cell 500.

A technique for depositing electroactive material on a portion of negative electrode 502 is described in U.S. Patent Publication No. 2016/0172660 and similarly in U.S. Patent Publication No. 2016/0172661, the contents of each of which are hereby incorporated herein by reference, to the extent such contents do not conflict with the present disclosure.

Negative electrode 502 and positive electrode 504 can further include one or more electronically conductive additives as described herein. In accordance with some embodiments of the disclosure, negative electrode 502 and/or positive electrode 504 further include one or more polymer binders as described below.

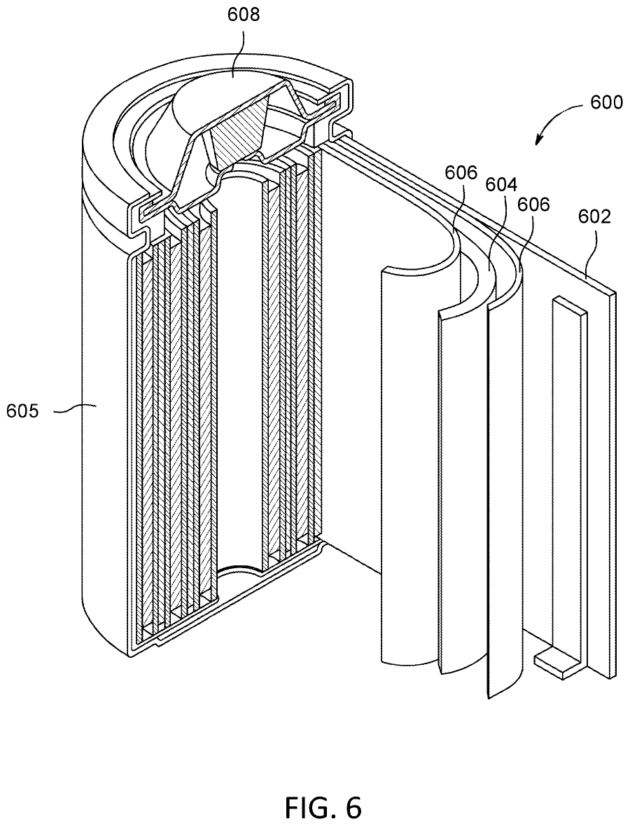

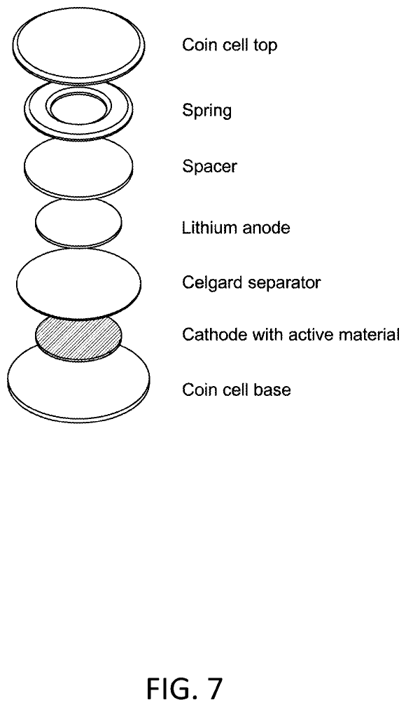

FIG. 6 illustrates an example of a battery according to various embodiments described below. A cylindrical battery is shown here for illustration purposes, but other types of arrangements, including prismatic or pouch (laminate-type) batteries, may also be used as desired. Example Li battery 600 includes a negative anode 602, a positive cathode 604, a separator 606 interposed between the anode 602 and the cathode 604, an electrolyte (not shown) impregnating the separator 606, a battery case 605, and a sealing member 608 sealing the battery case 605. It will be appreciated that example battery 600 may simultaneously embody multiple aspects of the present disclosure in various designs.

In some embodiments, a lithium-sulfur battery of the present disclosure includes a lithium anode, a sulfur-based cathode, and an electrolyte permitting ion transport between anode and cathode. In certain embodiments, described herein, an anodic portion of a battery includes an anode and a portion of electrolyte with which it is in contact. Similarly, in certain embodiments, described herein, a cathodic portion of a battery includes a cathode and a portion of electrolyte with which it is in contact. In certain embodiments, a battery includes a lithium ion-permeable separator, which defines a boundary between an anodic portion and a cathodic portion. In certain embodiments, a battery includes a case, which encloses both anodic and cathodic portions. In certain embodiments, a battery case includes an electrically conductive anodic-end cover in electrical communication with an anode, and an electrically conductive cathodic-end cover in electrical communication with a cathode to facilitate charging and discharging via an external circuit.

### Anodes

In certain embodiments, a lithium battery (e.g., a lithium-sulfur battery) includes a lithium anode. Any lithium anode suitable for use in lithium-sulfur cells may be used. In certain embodiments, an anode of a lithium-sulfur battery includes a negative active material selected from materials in which lithium intercalation reversibly occurs, materials that react with lithium ions to form a lithium-containing compound, metallic lithium, lithium alloys, and combinations thereof. In certain embodiments, an anode includes metallic lithium. In certain embodiments, lithium-containing anodic compositions include carbon-based compounds. In certain embodiments, a carbon-based compound is selected from the group consisting of crystalline carbon, amorphous carbon, graphite, and mixtures thereof. In certain embodiments, a material that reacts with lithium ions to form a lithium-containing compound is selected from the group consisting of tin oxide (SnO₂), titanium nitrate, and silicon. In certain embodiments, a lithium alloy includes an alloy of lithium with another alkali metal (e.g. sodium, potassium, rubidium or cesium). In certain embodiments, a lithium alloy includes an alloy of lithium with a transition metal. In certain embodiments, lithium alloys include alloys of lithium and a metal selected from the group consisting of Na, K, Rb, Cs, Fr, Be, Mg, Ca, Sr, Ba, Ra, Al, Sn, and combinations thereof. In certain embodiments, a lithium alloy includes an alloy of lithium with indium. In certain embodiments, an anode includes a lithium-silicon alloy. Examples of suitable lithium-silicon alloys include: Li₁₅Si₄, Li₁₂Si₇, Li₂Si₃, Li₁₃Si₄, and Li₂₁Si₅/Li₂₂Si₅. In certain embodiments, a lithium metal or lithium alloy is present as a composite with another material. In certain embodiments, such composites include materials such as graphite, graphene, metal sulfides or oxides, or conductive polymers.

An anode may be protected against redox shuttling reactions and hazardous runaway reactions by any of the methodologies reported in the art, for example, by creating a protective layer on a surface of an anode by chemical passivation or polymerization. For example, in certain embodiments, an anode includes an inorganic protective layer, an organic protective layer, or a mixture thereof, on a surface of lithium metal. In certain embodiments, an inorganic protective layer includes Mg, Al, B, Sn, Pb, Cd, Si, In, Ga, lithium silicate, lithium borate, lithium phosphate, lithium phosphoronitride, lithium silicosulfide, lithium borosulfide, lithium aluminosulfide, lithium phosphosulfide, lithium fluoride or combinations thereof. In certain embodiments, an organic protective layer includes a conductive monomer, oligomer, or polymer selected from poly(p-phenylene), polyacetylene, poly(p-phenylene vinylene), polyaniline, polypyrrole, polythiophene, poly(2,5-ethylene vinylene), acetylene, poly(perinaphthalene), polyacene, and poly(naphthalene-2,6-di-yl), or combinations thereof.

Moreover, in certain embodiments, inactive sulfur material, generated from an electroactive sulfur material of a cathode, during charging and discharging of a lithium-sulfur battery, attaches to an anode surface. The term “inactive sulfur”, as used herein, refers to sulfur that has no activity upon repeated electrochemical and chemical reactions, such that it cannot participate in an electrochemical reaction of a cathode. In certain embodiments, inactive sulfur on an anode surface acts as a protective layer on such electrode. In certain embodiments, inactive sulfur is lithium sulfide.

Anode-free (e.g., anode-less) configurations are also contemplated. In an anode-free configuration, a current collector is provided in place of an anode and an electrochemically active species, such as lithium in a lithium-sulfur battery, is deposited on a surface of the current collector during a first electrochemical cycle (or first few electrochemical cycles). Such lithium may be derived from an electrolyte and/or one or more additives in the electrochemical cell. The surface of the current collector then acts as a lithium source during further electrochemical cycling.

It is further contemplated that the present disclosure can be adapted for use in sodium-sulfur batteries. Such sodium-sulfur batteries include a sodium-based anode, and are encompassed within the scope of present disclosure.

### Preparation of Electrodes

There are a variety of methods for manufacturing electrodes for use in a lithium battery (e.g., a lithium-sulfur battery). One process, such as a “wet process,” involves adding a positive active material, a binder and a conducting material (i.e., a cathode mixture) to a liquid to prepare a slurry composition. These slurries are typically in the form of a viscous liquid that is formulated to facilitate a downstream coating operation. A thorough mixing of a slurry can be important for coating and drying operations, which affect performance and quality of an electrode. Suitable mixing devices include ball mills, magnetic stirrers, sonication, planetary mixers, high speed mixers, homogenizers, universal type mixers, and static mixers. A liquid used to make a slurry can be one that homogeneously disperses a positive active material, a binder, a conducting material, and any additives, and that is easily evaporated. Suitable slurry liquids include, for example, N-methylpyrrolidone, acetonitrile, methanol, ethanol, propanol, butanol, tetrahydrofuran, water, isopropyl alcohol, dimethylpyrrolidone, and the like.

In some embodiments, a prepared composition is coated on a current collector and dried to form an electrode. Specifically, a slurry is used to coat an electrical conductor to form an electrode by evenly spreading a slurry on to a conductor, which is then, in certain embodiments, roll-pressed (e.g. calendered) and heated as is known in the art. Generally, a matrix of a positive active material and conductive material are held together and on a conductor by a binder. In certain embodiments, a matrix includes a lithium conducting polymer binder, such as polyvinylidene fluoride (PVDF), poly(vinylidene fluoride-co-hexafluoropropene) (PVDF/HFP), Polytetrafluoroethylene (PTFE), Kynar Flex® 2801, Kynar® Powerflex LBG, Kynar® HSV 900, Teflon®, styrene butadiene rubber (SBR), polyethylene oxide (PEO), or polytetrafluoroethylene (PTFE). In certain embodiments, additional carbon particles, carbon nanofibers, carbon nanotubes, are dispersed in a matrix to improve electrical conductivity. Alternatively or additionally, in certain embodiments, lithium ions are dispersed in a matrix to improve lithium conductivity.

In certain embodiments, a current collector is selected from the group consisting of: aluminum foil, copper foil, nickel foil, stainless steel foil, titanium foil, zirconium foil, molybdenum foil, nickel foam, copper foam, carbon paper or fiber sheets, polymer substrates coated with conductive metal, and/or combinations thereof.

PCT Publication Nos. WO2015/003184, WO2014/074150, and WO2013/040067, the entire disclosures of which are hereby incorporated by reference herein, describe various methods of fabricating electrodes and electrochemical cells.

### Separators

In certain embodiments, an electrochemical cell (e.g., lithium-sulfur battery) includes a separator, which physically separates an anode and cathode. In certain embodiments, a separator is an impermeable material substantially, or completely, impermeable to electrolyte. In certain embodiments, a separator is impermeable to polysulfide ions dissolved in electrolyte. In certain embodiments, a separator as a whole is impermeable to electrolyte, such that passage of electrolyte-soluble sulfides is blocked. In some embodiments, a degree of ionic conductivity across a separator is provided, for example via apertures in such separator. In certain such embodiments, a separator as a whole inhibits or restricts passage of electrolyte-soluble sulfides between anodic and cathodic portions of a battery as a result of its impermeability. In certain embodiments, a separator of impermeable material is configured to allow lithium ion transport between anode and cathode of a battery during charging and discharging of a cell. In some such embodiments, a separator does not completely isolate an anode and a cathode from each other. One or more electrolyte-permeable channels bypassing, or penetrating through apertures in, an impermeable face of a separator should be provided to allow sufficient lithium ion flux between anodic and cathodic portions of a battery. In some embodiments, where a separator is itself completely impermeable, a channel is provided through an annulus between a periphery of a separator and walls of a battery case.

It will be appreciated by a person skilled in the art that optimal dimensions of a separator should balance competing imperatives: maximum impedance to polysulfide migration while allowing sufficient lithium ion flux. Aside from this consideration, shape and orientation of a separator is not particularly limited, and depends in part on battery configuration. For example, a separator may be substantially circular in a coin-type cell, and substantially rectangular in a pouch-type cell. As described herein, a surface of a separator may be devoid of apertures, so that lithium ion flux occurs exclusively around edges of an impermeable sheet. However, certain embodiments are also contemplated in which some or all of a required lithium ion flux is provided through apertures in a separator. In some embodiments, a separator is substantially flat. However, it is not excluded that curved or other non-planar configurations may be used.

A separator may be of any suitable thickness. In order to maximize energy density of a battery, it is generally preferred that a separator is as thin and light as possible. However, a separator should be thick enough to provide sufficient mechanical robustness and to ensure suitable impermeability. In certain embodiments, a separator has a thickness of from about 1 micron to about 200 microns, preferably from about 5 microns to about 100 microns, more preferably from about 10 microns to about 30 microns.

### Electrolytes

In certain embodiments, a lithium-sulfur battery includes an electrolyte including an electrolytic salt. Examples of electrolytic salts include, for example, lithium trifluoromethane sulfonimide, lithium triflate, lithium perchlorate, LiPF₆, LiBF₄, tetraalkylammonium salts (e.g. tetrabutylammonium tetrafluoroborate, TBABF₄), liquid state salts at room temperature (e.g. imidazolium salts, such as 1-ethyl-3-methylimidazolium bis-(perfluoroethyl sulfonyl)imide, EMIBeti), and the like.

In certain embodiments, an electrolyte includes one or more alkali metal salts. In certain embodiments, such salts include lithium salts, such as LiCF₃SO₃, LiClO₄, LiNO₃, LiPF₆, and lithium bis(trifluoromethanesulfonyl)imide (LiTFSI), or combinations thereof. In certain embodiments, an electrolyte includes ionic liquids, such as 1-ethyl-3-methylimidzaolium-TFSI, N-butyl-N-methyl-piperidinium-TFSI, N-methyl-n-butyl pyrrolidinium-TFSI, and N-methyl-N-propylpiperidinium-TFSI, or combinations thereof. In certain embodiments, an electrolyte includes superionic conductors, such as sulfides, oxides, and phosphates, for example, phosphorous pentasulfide, or combinations thereof.

In certain embodiments, an electrolyte is a liquid. For example, in certain embodiments, an electrolyte includes an organic solvent. In certain embodiments, an electrolyte includes only one organic solvent. In some embodiments, an electrolyte includes a mixture of two or more organic solvents. In certain embodiments, a mixture of organic solvents includes organic solvents from at least two groups selected from weak polar solvent groups, strong polar solvent groups, and lithium protection solvents.

The term “weak polar solvent,” as used herein, is defined as a solvent that is capable of dissolving elemental sulfur and has a dielectric coefficient of less than 15. In some embodiments, a weak polar solvent is selected from aryl compounds, bicyclic ethers, and acyclic carbonate compounds. Non-limiting examples of weak polar solvents include xylene, dimethoxyethane, 2-methyltetrahydrofuran, diethyl carbonate, dimethyl carbonate, toluene, dimethyl ether, diethyl ether, diglyme, tetraglyme, and the like. The term “strong polar solvent,” as used herein, is defined as a solvent that is capable of dissolving lithium polysulfide and has a dielectric coefficient of more than 15. In some embodiments, a strong polar solvent is selected from bicyclic carbonate compounds, sulfoxide compounds, lactone compounds, ketone compounds, ester compounds, sulfate compounds, and sulfite compounds. Non-limiting examples of strong polar solvents include hexamethyl phosphoric triamide, γ-butyrolactone, acetonitrile, ethylene carbonate, propylene carbonate, N-methylpyrrolidone, 3-methyl-2-oxazolidone, dimethyl formamide, sulfolane, dimethyl acetamide, dimethyl sulfoxide, dimethyl sulfate, ethylene glycol diacetate, dimethyl sulfite, ethylene glycol sulfite, and the like. The term “lithium protection solvent”, as used herein, is defined as a solvent that forms a good protective layer, i.e. a stable solid-electrolyte interface (SEI) layer, on a lithium surface, and which shows a cyclic efficiency of at least 50%. In some embodiments, a lithium protection solvent is selected from saturated ether compounds, unsaturated ether compounds, and heterocyclic compounds including one or more heteroatoms selected from the group consisting of N, O, and/or S. Non-limiting examples of lithium protection solvents include tetrahydrofuran, 1,3-dioxolane, 3,5-dimethylisoxazole, 2,5-dimethyl furan, furan, 2-methyl furan, 1,4-oxane, 4-methyldioxolane, and the like.

In certain embodiments, an electrolyte is a liquid (e.g., an organic solvent). In some embodiments, a liquid is selected from the group consisting of organocarbonates, ethers, sulfones, water, alcohols, fluorocarbons, or combinations of any of these. In certain embodiments, an electrolyte includes an ethereal solvent.

In certain embodiments, an organic solvent includes an ether. In certain embodiments, an organic solvent is selected from the group consisting of 1,3-dioxolane, dimethoxyethane, diglyme, triglyme, γ-butyrolactone, γ-valerolactone, and combinations thereof. In certain embodiments, an organic solvent includes a mixture of 1,3-dioxolane and dimethoxyethane. In certain embodiments, an organic solvent includes a 1:1 v/v mixture of 1,3-dioxolane and dimethoxyethane. In certain embodiments, an organic solvent is selected from the group consisting of: diglyme, triglyme, γ-butyrolactone, γ-valerolactone, and combinations thereof. In certain embodiments, an electrolyte includes sulfolane, sulfolene, dimethyl sulfone, or methyl ethyl sulfone. In some embodiments, an electrolyte includes ethylene carbonate, propylene carbonate, dimethyl carbonate, diethyl carbonate, or methylethyl carbonate.

In certain embodiments, an electrolyte includes a liquid (e.g., an organic solvent). In some embodiments, a liquid is selected from the group consisting of organocarbonates, ethers, sulfones, water, alcohols, fluorocarbons, or combinations of any of these. In certain embodiments, an electrolyte includes an ethereal solvent. In certain embodiments, an electrolyte includes a liquid selected from the group consisting of sulfolane, sulfolene, dimethyl sulfone, and methyl ethyl sulfone. In certain embodiments, an electrolyte includes a liquid selected from the group consisting of ethylene carbonate, propylene carbonate, dimethyl carbonate, diethyl carbonate, and methylethyl carbonate.

In certain embodiments, an electrolyte is a solid. In certain embodiments, a solid electrolyte includes a polymer. In certain embodiments, a solid electrolyte includes a glass, a ceramic, an inorganic composite, or combinations thereof. In certain embodiments, a solid electrolyte includes a polymer composite with a glass, a ceramic, an inorganic composite, or combinations thereof. In certain embodiments, such solid electrolytes include one or more liquid components as plasticizers or to form a “gel electrolyte.”

### EXAMPLES

In order that the application may be more fully understood, the following examples are set forth. It should be understood that these examples are for illustrative purposes only and are not to be construed as limiting in any manner.

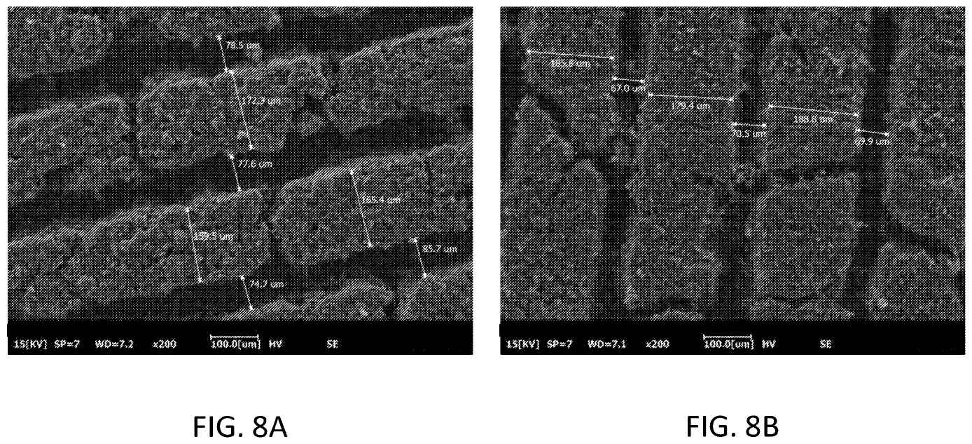

Structured conversion cathodes suitable for use in lithium-sulfur batteries have been constructed and their microstructures assessed by SEM. FIGS. 8A-8B show examples of structured cathodes that include a cathode film, which includes electrochemically active material, that has trenches recessed into a patterned surface of the film with a consistent width and/or consistent spacing across the patterned surface. The films had a ratio of individual structures of electrochemically active conversion material to conductive carbon to binder of about 10:5:4, for example about 55% sulfur, about 25% conductive carbon, and about 20% binder. Overall, the cathodes tested had an electrochemically active sulfur content of about 3-3.5 mg/cm². Using laser ablation, trench widths and spacings can be tuned as desired. For example, a laser with power characterized by a 35 μm circle @~400-600 μs may be used to form trenches. For example, FIG. 8A shows a structured cathode that includes trenches that are about 80 μm in width and spaced apart by about 165 μm. As another example, FIG. 8B shows a structured cathode that includes trenches that are about 70 μm in width and spaced apart by about 185 μm. Wider or narrower trenches and/or further or closer spacings between trenches may be used.

The 3D structured cathode samples (that included patterned surfaces) were tested compared to a control cathode (that was unpatterned) of similar composition. A comparison between the particular sample shown in FIG. 8B (“3D Structured Cathode”) and the control (“Control”) at the 3^{rd} and 5^{th} cycles is provided in Table 1.

TABLE 1

| | |
|---|---|
| Cycle 3 | Cycle 5 |

| | Rate | Capacity | Rate | Capacity |
|---|---|---|---|---|
| | (mA/g) | (mAh/g S) | (mA/g) | (mAh/g S) |
| 3D Structured | 438.2 | 936.6 | 134.8 | 1079.5 |
| Cathode | | | | |
| Control | 387.2 | 863.3 | 119.1 | 996 |

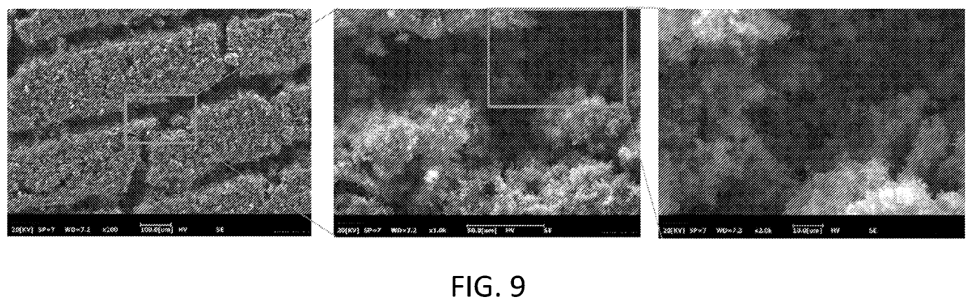

FIG. 9 shows a structured conversion cathode suitable for use in a lithium-sulfur battery that has consistent morphology inside of trenches that extend into a surface of the cathode film as it does at an uppermost portions of the surface of the cathode. The trenches have been formed by laser ablation. The left panel shows the lease magnified view. The area inside of the red box is expanded to form the view of the center panel and the area inside of that red box is further expanded to form the view of the right most panel. As can be seen by close inspection of the progressive magnification of this example, the surfaces of the trenches present a similar (e.g., identical) morphology and porosity to that of the uppermost portions of the cathode that have not been ablated (e.g., and therefore presumably also bulk of the cathode film).

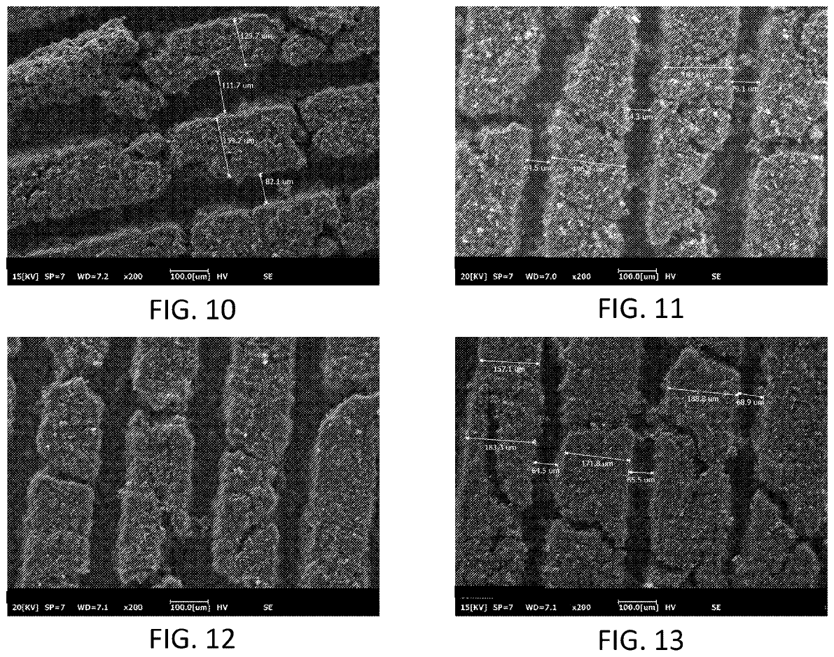

FIGS. 10-13 show additional constructed examples of structured cathodes. The structured cathodes include a film including electrochemically active conversion material where recesses that are trenches have been formed in a surface of the film using laser ablation. The recesses extend into but not entirely through the film (e.g., do not expose the current collector underneath the film). These structured cathodes are suitable for use in lithium-sulfur batteries.

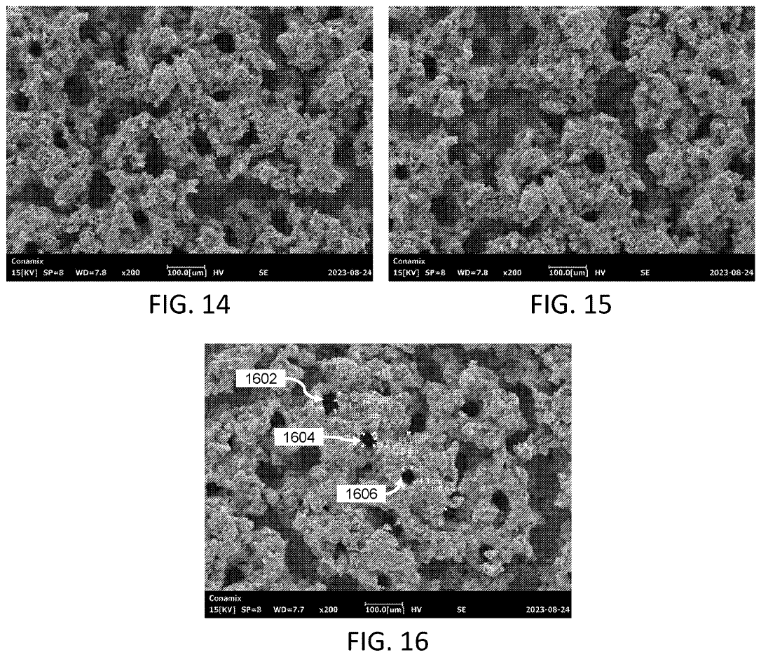

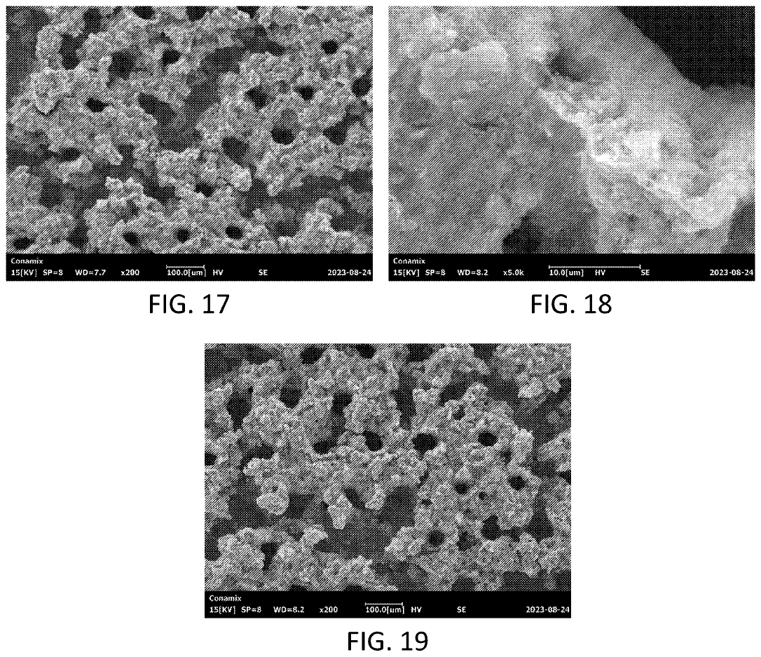

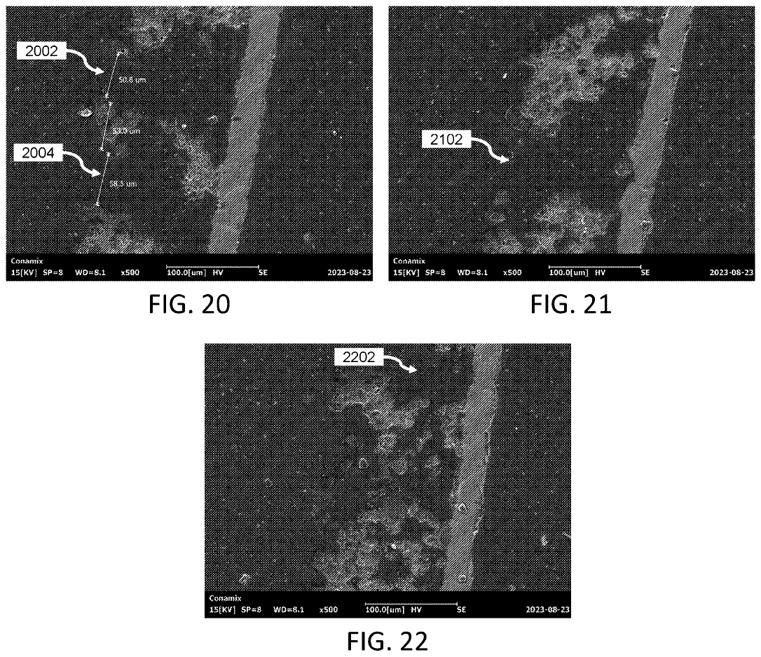

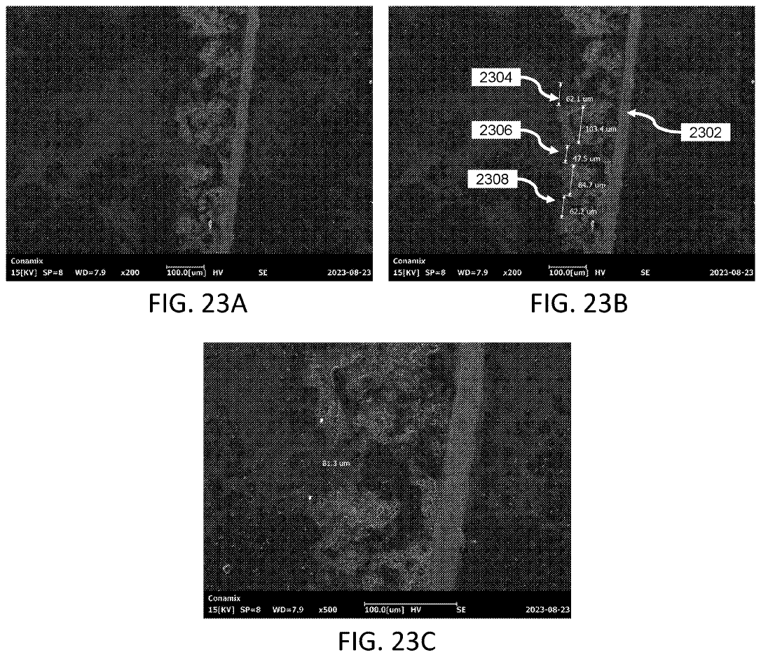

FIGS. 14-23C show additional constructed examples of structured cathodes. The examples include a cathode film, which includes electrochemically active material that has holes recessed into a patterned surface of the film with a consistent diameter and/or consistent spacing across the patterned surface. The films had a composition of (i) 80 wt % of a blend of sulfur and a metal sulfide additive; (ii) 10 wt % carbon (e.g., C65 and Ketjen Black); and (iii) 10 wt % binder (e.g., Na-PAA). FIGS. 14-19 show a top view of calendered films (FIGS. 14-16) and uncalendered films (FIGS. 17-19). FIGS. 20-23C show a cross-section view of calendered films (FIGS. 20-22) and uncalendered films (FIGS. 23A-23C). The hole pattern corresponded to a hexagonal grid similar to a hexagonal close-packed (HCP) arrangement characteristic of the (111) plane of a face centered cubic (FCC) structure. FIGS. 14-19 shows a structured cathode that includes holes (e.g., holes 1602, 1604, and 1606) that are about 50 μm in width and spaced apart by about 100 μm. Wider or narrower holes and/or further or closer spacings between holes may be used.

High magnification SEM images, such as presented in FIG. 18, demonstrate laser ablation created well-defined holes. Cross-section images for both calendered films (FIGS. 20-22) and uncalendered films (FIGS. 23A-23C) demonstrate that laser ablation created consistent holes in the films, for example, holes 2002 and 2004 in FIG. 20, hole 2102 in FIG. 21, and hole 2202 in FIG. 22. FIGS. 23A-23C demonstrate that, in some cases, holes (e.g., holes 2304, 2306, 2308) do not extend to a substrate 2302. Additionally, holes were observed to intersect with pores of structures in cathode films.

A comparison between the particular samples shown in FIGS. 17-19 and FIGS. 23A-23C (“3D Structured Cathode” including holes, uncalendered) at the 3^{rd} and 5^{th} cycles is provided in Table 2.

TABLE 2

| | |
|---|---|
| Cycle 3 | Cycle 5 |

| | Rate | Capacity | Rate | Capacity |
|---|---|---|---|---|
| | (mA/g) | (mAh/g S) | (mA/g) | (mAh/g S) |
| 3D Structured | 333 | 1029.92 | 100 | 1067.5 |
| Cathode | | | | |
| Control | 333 | 990.653 | 100 | 1029.50 |

Structured cathodes were also tested against control cathodes at the same current density (mA/cm²). The material rate (mA/g active) was increased for the experimental structured cathodes. Without wishing to be bound by any particular theory, the increased material rate can be at least partially explained by the material removed to form recesses in the patterned surface of the experimental structured cathodes.

It is contemplated that systems, devices, methods, and processes of the disclosure encompass variations and adaptations developed using information from the embodiments described herein. Adaptation and/or modification of the systems, devices, methods, and processes described herein may be performed by those of ordinary skill in the relevant art.

Throughout the description, where articles, devices, and systems are described as having, including, or comprising specific components, or where processes and methods are described as having, including, or comprising specific steps, it is contemplated that, additionally, there are articles, devices, and systems according to certain embodiments of the present disclosure that consist essentially of, or consist of, the recited components, and that there are processes and methods according to certain embodiments of the present disclosure that consist essentially of, or consist of, the recited processing steps.

It should be understood that the order of steps or order for performing certain action is immaterial so long as operability is not lost. Moreover, two or more steps or actions may be conducted simultaneously. As is understood by those skilled in the art, the terms “over”, “under”, “above”, “below”, “beneath”, and “on” are relative terms and can be interchanged in reference to different orientations of the layers, elements, and substrates included in the present disclosure. For example, a first layer on a second layer, in some embodiments means a first layer directly on and in contact with a second layer. In other embodiments, a first layer on a second layer can include another layer there between.

Headers have been provided for the convenience of the reader and are not intended to be limiting with respect to the claimed subject matter. Statements made in the background section are not to be construed as admissions that they are prior art.

Certain embodiments of the present disclosure were described above. It is, however, expressly noted that the present disclosure is not limited to those embodiments, but rather the intention is that additions and modifications to what was expressly described in the present disclosure are also included within the scope of the disclosure. Moreover, it is to be understood that the features of the various embodiments described in the present disclosure were not mutually exclusive and can exist in various combinations and permutations, even if such combinations or permutations were not made express, without departing from the spirit and scope of the disclosure. The disclosure has been described in detail with particular reference to certain embodiments thereof, but it will be understood that variations and modifications can be effected within the spirit and scope of the claimed invention.

What is claimed is:

1. A conversion cathode for a secondary lithium battery (e.g., a lithium-sulfur battery), the cathode comprising a film comprising an electrochemically active conversion material, the film having a first surface in contact with a substrate (e.g., current collector) and a patterned second surface on a side of the film opposite the first surface (e.g., not in contact with the substrate), wherein the patterned second surface comprises recesses that extend into the film toward the substrate (e.g., in a direction substantially perpendicular to the first surface).

2. The conversion cathode of claim 1, wherein the patterned second surface of the film has a repeating geometric pattern of the recesses.

3. The conversion cathode of claim 2, wherein the repeating geometric pattern conforms to a hexagonal grid.

4. The conversion cathode of claim 2, wherein the repeating geometric pattern conforms to an isometric grid or to a square grid.

5. The conversion cathode of any one of the preceding claims, wherein at least a portion (e.g., all) of the recesses are interconnected across the second surface (e.g., form a network of the recesses across an extent of the second surface).

6. The conversion cathode of any one of the preceding claims, wherein the recesses in the second surface of the film comprise holes.

7. The conversion cathode of claim 6, wherein the holes are substantially circular in cross section.

8. The conversion cathode of claim 7, wherein a diameter of the holes is at least 20 nm and no more than 500 μm (e.g., 20 nm to 50 μm, 20 nm to 100 μm, 20 nm to 200 μm, 20 nm to 300 μm, 100 nm to 100 μm, 100 nm to 200 μm, 1 μm to 100 μm, 1 μm to 200 μm, 10 μm to 100 μm, 10 μm to 200 μm, 50 μm to 100 μm, 50 μm to 200 μm, or 100 μm to 200 μm).

9. The conversion cathode of any one of claims 6-8, wherein the holes each have a depth that is at least 25% of a thickness of the cathode film (e.g., a depth that is at least 50%, at least 75%, at least 80% or at least 90% of the thickness of the cathode film) or wherein the holes extend entirely through the film from the second surface to the first surface.

10. The conversion cathode of any one of the preceding claims, wherein the recesses comprise trenches.

11. The conversion cathode of claim 10, wherein the trenches have a width and a length across the second surface, the width is less than the length, and the width is at least 20 nm and no more than 500 μm (e.g., 20 nm to 50 μm, 20 nm to 100 μm, 20 nm to 200 μm, 20 nm to 300 μm, 100 nm to 100 μm, 100 nm to 200 μm, 1 μm to 100 μm, 1 μm to 200 μm, 10 μm to 100 μm, 10 μm to 200 μm, 50 μm to 100 μm, 50 μm to 200 μm, or 100 μm to 200 μm).

12. The conversion cathode of claim 10 or claim 11, wherein the trenches each have a depth that is at least 25% of a thickness of the cathode film (e.g., a depth that is at least 50%, at least 75%, at least 80% or at least 90% of the thickness of the cathode film) or wherein the trenches extend entirely through the film from the second surface to the first surface.

13. The conversion cathode of any one of the preceding claims, wherein the recesses are at least partially filled with electrolyte.

14. The conversion cathode of claim 13, wherein the electrolyte is a liquid.

15. The conversion cathode of claim 13, wherein the electrolyte comprises a polymer.

16. The conversion cathode of claim 13 or claim 15, wherein the electrolyte is a solid.

17. The conversion cathode of any one of the preceding claims, wherein the recesses are distributed in a regular pattern across the second surface of the film.

18. The conversion cathode of any one of the preceding claims, wherein the recesses are distributed across the second surface such that no point within the film is more than 500 μm (e.g., no more than 200 μm, no more than 100 μm, no more than 50 μm, no more than 25 μm, or no more than 20 μm) from at least one edge of at least one of the recesses.

19. The conversion cathode of any one of the preceding claims, wherein the recesses are distributed across the second surface such that any point within the film is within a distance of a closest one of the recesses that is no more than three times (e.g., no more than twice or no more than 1.5×) a maximum thickness of the film.

20. The conversion cathode of claim 19, wherein the distance is no more than the maximum thickness of the film.

21. The conversion cathode of any one of the preceding claims, wherein the recesses represent at least 5% (e.g., at least 10%, at least 15%, at least 20%, at least 25%, at least 33% or at least 50%) of total volume contained between a plane coincident with an uppermost portion of the second surface and the first surface.

22. The conversion cathode of any one of the preceding claims, surfaces of the recesses (e.g., portions of the second surface defined by the recesses) are coated with a solid material having a composition different from composition of bulk cathode in the film.

23. The conversion cathode of claim 22, wherein the surfaces of the recesses are coated with a solid epitaxial material (e.g., formed by atomic layer deposition after formation of the recesses).

24. The conversion cathode of any one of the preceding claims, wherein the film is a first film and the conversion cathode further comprises a second film disposed on a side of the substrate opposite the first film.

25. The conversion cathode of claim 24, wherein the second film has a patterned second surface comprising recesses that extend into the second film and a first surface opposing the second surface, wherein the first surface of the second film is in contact with the substrate.

26. The conversion cathode of claim 24 or claim 25, wherein the substrate is porous.

27. The conversion cathode of claim 26, wherein the recesses in the first film extend entirely through the first film and intersect with pores in the substrate.

28. The conversion cathode of any one of claims 25-27, wherein the recesses in the second film extend entirely through the second film and intersect with pores in the substrate.

29. The conversion cathode of claim 27 or claim 28, wherein the pores in the substrate extend entirely through the substrate (e.g., thereby defining pores entirely through the cathode).

30. The conversion cathode of any one of the preceding claims, wherein the second surface of the film has been patterned after the film has been applied to the substrate.

31. The conversion cathode of claim 30, wherein the film has been produced by applying a wet slurry to the substrate and subsequently drying the slurry prior to patterning.

32. The conversion cathode of claim 30 or claim 31, wherein the film has been calendered prior to patterning the second surface.

33. The conversion cathode of any one of the preceding claims, wherein the second surface has been patterned by laser ablation.

34. The conversion cathode of claim 33, wherein the laser ablation patterned the second surface using a pulsed laser.

35. The conversion cathode of claim 34, wherein the pulsed laser applied pulses of a duration of less than 1000 femtoseconds (e.g., less than 500, 400, 300, 200, 150, 100, 50, 25, 15, 10, 5, 4, 3, 2, or 1 fs).

36. The conversion cathode of any one of the preceding claims, wherein the film is porous [e.g., is a porous assembly of individual structures (e.g., particles) (e.g., nanoparticles) (e.g., core-shell or yolk-shell particles)].

37. The conversion cathode of any one of the preceding claims, wherein the electrochemically active conversion material comprises (i) elemental sulfur (e.g., in its S₈ cyclic octatomic molecular form), (ii) sulfur in the form of a lithium sulfide (e.g., Li₂S₂ and/or Li₂S), (iii) sulfur in the form of an electrochemically active organosulfur compound, (iv) sulfur in the form of an electrochemically active sulfur-containing polymer, or (v) a combination of any two or more of (i)-(iv).

38. The conversion cathode of any one of the preceding claims, wherein the cathode film further comprises one or more metal sulfides.

39. The conversion cathode of claim 38, wherein at least one of the one or more metal sulfides is an intercalation electrochemically active material.

40. The conversion cathode of any one of the preceding claims, further comprising a conductive additive (e.g., conductive carbon).

41. The conversion cathode of any one of the preceding claims, further comprising a polymer binder.

42. The conversion cathode of any one of the preceding claims, wherein the cathode is substantially devoid of carbon (e.g., no more than 10 wt % carbon, no more than 5 wt % carbon, no more than 2 wt % carbon, or no more than 1 wt % carbon).

43. The conversion cathode of any one of the preceding claims, wherein:
(i) an average mass transport path to the electrochemically active conversion material is shorter than an average mass transport path to electrochemically active conversion material in an otherwise equivalent cathode without the recesses;
(ii) a tortuosity of the cathode is reduced compared to a tortuosity of an otherwise equivalent cathode without the recesses; or
(iii) both (i) and (ii).

44. The conversion cathode of any one of the preceding claims, wherein:
(i) a capacity of the cathode is greater than a capacity of an otherwise equivalent cathode without the recesses at a same current density;
(ii) the cathode has a high volumetric capacity; or
(iii) both (i) and (ii).

45. The conversion cathode of any one of the preceding claims, wherein at least some (e.g., all) of the recesses extend entirely through the film.

46. The conversion cathode of any one of the preceding claims, wherein at least some (e.g., all) of the recesses do not extend entirely through the film.

47. A (e.g., lithium-sulfur) secondary battery comprising the conversion cathode of any one of claims 1-46.

48. The battery of claim 47, further comprising an electrolyte disposed in the film, wherein the recesses are local reservoirs for portions of the electrolyte displaced from bulk of the film during electrochemical cycling of the battery.

49. The battery of claim 46 or claim 48, further comprising a liquid electrolyte that at least partially fills the recesses (e.g., wherein the liquid electrolyte also directly contacts the second surface where not recessed).

50. The battery of claim 47, further comprising a solid, polymer, or gel electrolyte (e.g., polymer gel electrolyte) that at least partially fills the recesses.

51. The battery of claim 50, further comprising a liquid electrolyte that is in contact with the solid, polymer, or gel electrolyte (e.g., wherein the liquid electrolyte is disposed in the recesses and the solid, polymer, or gel electrolyte directly contacts the second surface).

52. The battery of any one of claims 47-51, further comprising a non-conductive separator, wherein the second surface of the film is in contact with the non-conductive separator (e.g., at non-recessed portions of the second surface) [e.g., thereby defining a separator-cathode interface and wherein non-equilibrium insoluble product is disposed (e.g., precipitated) at a higher concentration on the surface of the film at the separator-cathode interface than in the recesses].

53. The battery of any one of claims 47-51, further comprising a solid electrolyte, wherein the second surface of the film is in contact with the solid electrolyte (e.g., at non-recessed portions of the second surface).

54. The battery of any one of claims 47-51, further comprising a protected lithium anode wherein the second surface of the film is in contact with the protected lithium anode.

55. The battery of any one of claims 47-53, wherein the battery has an anode-free configuration (e.g., wherein the battery comprises a current collector and lithium deposits on the current collector during a first electrochemical cycle).

56. The battery of any one of claims 48-55, wherein the electrolyte does not include a sulfonamide salt (e.g., lithium bis(trifluoromethanesulfonyl)imide (LiTFSI)).

57. The battery of any one of claims 47-56, wherein the battery has a low electrolyte to sulfur (E/S) ratio.

58. A method of operating (i) a battery (e.g., lithium-sulfur battery) comprising a cathode according to any one of claims 1-46 and an electrolyte or (ii) a battery according to any one of claims 47-57, the method comprising expanding the film during electrochemical cycling of the battery (e.g., while discharging the battery) [e.g., due to expanding of individual structures (e.g., particles) assembled in the film] (e.g., due to reduced porosity in the film) such that a portion of the electrolyte is displaced from bulk of the film into the recesses.

59. The method of claim 58, further comprising displacing the portion of the electrolyte back into the bulk of the film during further electrochemical cycling of the battery (e.g., while charging the battery) (e.g., due to shrinkage of the film).

60. The method of claim 58 or claim 59, wherein the battery further comprises a separator in contact with the second surface of the film thereby defining a separator-cathode interface and the method comprises:
forming non-equilibrium insoluble product during electrochemical cycling; and
disposing (e.g., precipitating) the non-equilibrium insoluble product on the surface of the film at the separator-cathode interface.

61. The method of claim 60, wherein the non-equilibrium insoluble product disposes on the surface of the film at the separator-cathode interface at a higher concentration than the non-equilibrium insoluble product disposes in the recesses.

62. The method of claim 61, wherein the non-equilibrium insoluble product is not disposed in the recesses.

63. The method of any one of claims 60-62, comprising reversibly transporting lithium (e.g., in the form of a polysulfide) into the cathode via the recesses during electrochemical cycling.

64. The method of claim 63, wherein the transporting of lithium into the cathode via the recesses occurs at a higher rate and/or to a greater extent (e.g., based on an amount of lithium transported) than a rate and/or extent that transporting lithium through surface having the non-equilibrium insoluble product disposed thereon simultaneously occurs.

65. The method of any one of claims 58-64, wherein electrolyte displacement into a cell stack and/or one or more voids of the battery during electrochemical cycling is reduced due to the displacement into the recesses.

66. A method of making a cathode for a battery (e.g., a lithium-sulfur battery), the method comprising:
providing (e.g., forming) a film comprising electrochemically active conversion material; and
forming recesses in a surface of the film that extend into the film.

67. The method of claim 66, wherein the forming comprises removing a portion of the film.

68. The method of claim 67, wherein the removing comprises laser ablating the film.

69. The method of claim 68, wherein the laser ablating comprises applying a pulsed laser to the film.

70. The method of claim 69, the pulsed laser applies pulses of a duration of less than 1000 femtoseconds (e.g., less than 500, 400, 300, 200, 150, 100, 50, 25, 15, 10, 5, 4, 3, 2, or 1 fs).

71. The method of any one of claims 68-70, wherein the laser ablating is performed in-line (e.g., during fabrication of a battery).

72. The method of any one of claims 66-71, comprising calendering the film [e.g., on a substrate (e.g., current collector)].

73. The method of claim 72, wherein the forming occurs after the calendering.

74. The method of claim 73, wherein (i) the calendering has left no more than 40% (e.g., no more than 30%, no more than 20%, or no more than 10%) of an initial porosity of the film before calendering, (ii) a maximum thickness of the film is no more than 40% (e.g., no more than 30%, no more than 20%, or no more than 10%) of an initial thickness before calendering, or (iii) both (i) and (ii).

75. The method of any one of claims 66-74, wherein the forming comprises scraping, cutting, and/or scratching (e.g., with one or more blades).

76. The method of any one of claims 66-75, wherein the forming comprises debossing (e.g., compacting, imprinting, and/or stamping) the film.

77. The method of any one of claims 66-76, wherein the providing comprises forming the film, wherein forming the film comprises assembling individual structures (e.g., particles) comprising the electrochemically active material.

78. The method of claim 77, wherein the assembling comprises one or more members selected from the group consisting of slurry coating, slot-die coating, spin coating, spray drying, draw-down coating, doctor-blade coating, inkjet printing, comma-coating, and reverse comma-coating.

79. The method of any one of claims 66-78, wherein the method is performed as part of a roll-to-roll manufacturing process (e.g., a roll-to-roll cathode manufacturing process or roll-to-roll battery manufacturing process).

80. The method of any one of claims 66-79, wherein the cathode is a cathode according to any one of claims 1-46.
